(19) United States
(12) Patent Application Publication
(10) Pub. No.: US 2004/0098748 A1
(43) Pub. Date: May 20, 2004

(54) MPEG-4 live unicast video streaming system in wireless network with end-to-end bitrate-based congestion control

(76) Inventors: Lan Bo, Singapore (SG); Heu Chang Chih, Singapore (SG)

Correspondence Address: LOUIS WOO, LAW OFFICE OF LOUIS WOO, 717 NORTH FAYETTE STREET, ALEXANDRIA, VA, 22314, US

(21) Appl. No.: 10/699,913

(22) Filed: Nov. 4, 2003

(30) Foreign Application Priority Data
Nov. 20, 2002 (SG) 200207018-3

(51) Int. Cl. H04N 7/173; H04N 7/12

(52) U.S. Cl. 725/105; 375/240.08; 725/95

(57) ABSTRACT

With end-to-end congestion control, in an MPEG-4 live unicast video streaming system in a wireless network, a streaming server provides real-time video-streaming to a client by using an RTP/UDP protocol. RTP/RTCP transport engines handle the segmentation/desegmentation and the packetization/depacketization of data as well as the transmission/retransmission of packets. A bitrate adaptation protocol and a network bandwidth polling protocol can automatically and dynamically adjust the data-bitrate/transmission-bitrate according to the available network bandwidth. Therefore, the continuous live video-streaming service is promised.

### BACKGROUND OF THE INVENTION

1. Field of the Invention

This invention relates to an MPEG-4 live unicast streaming system in wireless network with end-to-end bitrate-based congestion control.

2. Description of the Related Art

Due to the success of the Internet technology and an increasing demand for multimedia information on the web, streaming video over the Internet has been becoming a key topic in academia and industry.

Conventionally, video files are downloaded from the Internet and played back locally. But full file transfer tends to introduce very long, unacceptable transfer time and playback latency. No live streaming is supported.

Recently, with the emergence of wideband network such as DSL (digital subscriber loop) or cable modems, real-time video streaming over the Internet has been widely accepted and deployed. In real-time video streaming, live video or stored video is streamed across the Internet from the server to the client in response to a client's request. The client plays back the incoming video in real time when the data is received.

There are several key areas of real-time video streaming such as video compression, application-layer QoS (quality of service) control, continuous media distribution services, streaming servers, media synchronization mechanisms, and protocols for streaming media. Typically, real-time video streaming has bandwidth, delay, and loss requirements. For instance, video data is required to be played back continuously at the client. If the data does not arrive in time, the playback probably has to be paused to wait for the delayed or lost data. The playback pause is annoying to the user. However, the current best-effort Internet does not offer any QoS guarantees to streaming video. One solution is the application-layer QoS control, which does not require any QoS support from the network, to avoid congestion and maximize video quality in the presence of packet loss and transmission delay. For video streaming, typical application-layer congestion control takes the form of rate control which attempts to match the bitrate of the video stream to the available network bandwidth.

One popular rate control is RAP (rate adaptation protocol) which is end-to-end TCP-friendly. The RAP is designed as follows. Video data is streamed through a TCP connection. In the feedback TCP acknowledgement, there is the information of RTT (round-trip time), packet loss ratio, etc. Then, an estimated current network bandwidth is achieved to adjust the sending data bitrate of a pre-stored video stream.

Another popular rate control is receiver-based rate control which is mainly used in multicasting scalable video streams. The receiver-based rate control is designed as follows. There are several layers in the scalable video, and each layer corresponds to one channel in the multicast tree. When congestion is detected, a receiver drops a layer resulting in a reduction of its receiving rate whereas the sender does not participate in rate control.

Now quite a few protocols have been designed and standardized for communications between clients and streaming servers. Obviously, IP serves as the network-layer protocol for the Internet video streaming. Since TCP's retransmission feature always introduces delays that are not acceptable for video streaming applications with stringent delay requirements, UDP is now typically employed as the transport protocol for video streaming. In addition, RTP/RTCP (real-time transport protocol/real-time control protocol) is designed to provide end-to-end transport functions on top of UDP for supporting real-time applications. Moreover, RTSP (real-time streaming protocol) defines the messages and procedures to control the delivery of the multimedia data during an established session.

With the explosive development on wireless networks, more and more people are now using wireless LANs or even their hand-phones and PDAs to access the Internet. However, compared to a wired network, wireless links are more error-prone, bandwidth-limited and time varying. Thanks to the flexibility and efficiency of MPEG-4 technology, video streaming inclusive of live video streaming through a wireless network becomes available.

### SUMMARY OF THE INVENTION

In view of the foregoing, it is an object of this invention to provide an MPEG-4 live unicast video streaming system in a wireless network that allows the streaming server to provide continuous video streaming service over a best-effort network.

It is another object of this invention to provide an MPEG-4 live unicast video streaming system in a wireless network that allows the client to receive data in real time and decode the data properly.

A first aspect of this invention provides an MPEG-4 live unicast video streaming system for use in a wireless network including an end-to-end congestion control mechanism that can automatically and dynamically adjust a data-bitrate/transmission bitrate according to an available network bandwidth. The system comprises (1) a rate adaptive MPEG-4 simple profile encoder for generating MPEG-4 simple profile live video data through an encoding process with an adjustable encoding bitrate, for transmitting the generated MPEG-4 simple profile live video data by HTTP/TCP through a LAN, and for adjusting the encoding bitrate in accordance with a bitrate control requirement; (2) a streaming server; (2a) a data receiver module provided in the streaming server for receiving the MPEG-4 simple profile live video data by HTTP/TCP from the rate adaptive MPEG-4 simple profile encoder through the LAN; (2b) an RTSP server module provided in the streaming server for handling a streaming session; (2c) an RTP/RTCP transport engine server module provided in the streaming server for segmentizing the MPEG-4 simple profile live video data received by the data receiver module on the basis of GOVs, for packetizing each GOV as payload of RTP packets, and for transmitting the RTP packets through a wireless network according to a bitrate of each GOV, whereas RTCP is implemented for transporting retransmission request and reply; (2d) a bitrate adapter module provided in the streaming server for implementing a bitrate adaptation protocol and a network bandwidth polling protocol to allow the streaming server to proceed with bitrate control tasks, and forwarding an incoming bitrate control decision to the rate adaptive MPEG-4 simple profile encoder as the bitrate control requirement; (2e) a data link buffer provided in the streaming server for storing the MPEG-4 simple profile live video data received by the data receiver module as MPEG-4 GOV data; (3) a client; (3a) a rate adaptive MPEG-4 simple profile decoder provided in the client for decoding received MPEG-4 GOV data and rendering pictures represented by the received MPEG-4 GOV data; (3b) an RTSP client module provided in the client for handling the streaming session; (3c) an RTP/RTCP transport engine client module provided in the client for receiving the RTP packets from the streaming server through the wireless network, for depacketizing and desegmentizing the payload of the received RTP packets to each GOV of MPEG-4 GOV data, whereas RTCP is implemented for transporting retransmission request and reply; (3d) a bitrate adapter module provided in the client for implementing the bitrate adaptation protocol and the network bandwidth polling protocol to allow the client to proceed with bitrate control tasks, and for forwarding the bitrate control decision to the streaming server; and (3e) a data link buffer provided in the client for storing the MPEG-4 GOV data generated by the RTP/RTCP transport engine client module, for collecting bitrate control information, and for forwarding the collected bitrate control information to the bitrate adapter module in the client.

A second aspect of this invention is based on the first aspect thereof, and provides an MPEG-4 live unicast video streaming system wherein the data link buffer in the streaming server comprises means for storing the MPEG-4 simple profile live video data as a link of GOVs with related information representative of parameters including a GOV bitrate, a GOV duration, and a GOV size; interfaces for inserting a GOV, reading out a GOV, and searching for a GOV; and means for, when a speed of GOV reading is slower than a speed of GOV inserting, allowing overwriting an old unread GOV with resynchronization of read and write pointers by resetting a buffer status and dropping rest unread GOVs.

A third aspect of this invention is based on the first aspect thereof, and provides an MPEG-4 live unicast video streaming system wherein the RTP/RTCP transport engine server module comprises means for segmentizing and packetizing each GOV into RTP packets and then packing one RTP packet as payload of one UDP packet, and for pushing the UDP packet to the client through the wireless network according to a data bitrate; means for receiving a retransmission request from the client through a UDP connection which loads an RTCP packet with information representative of the retransmission request; means for, upon receiving the retransmission request, searching the data link buffer in the streaming server for a required GOV; means for, when the required GOV is found, retransmitting at least a portion of the required GOV which contains required data to the client using RTP packets; and means for, when the required GOV fails to be found, returning a negative acknowledgement of forbidden-retransmission to the client through an RTCP channel.

A fourth aspect of this invention is based on the first aspect thereof, and provides an MPEG-4 live unicast video streaming system wherein the bitrate adapter module in the streaming server comprises means for receiving the bitrate control information from the client as the bitrate control decision and proceeding with bandwidth polling with cooperation of the client; and means for forwarding the bitrate control decision to the rate adaptive MPEG-4 simple profile encoder as the bitrate control requirement.

A fifth aspect of this invention is based on the first aspect thereof, and provides an MPEG-4 live unicast video streaming system wherein the data link buffer in the client comprises means for storing the MPEG-4 simple profile live video data as a link of GOVs with related information representative of parameters including a GOV bitrate, a GOV duration, and a GOV size; interfaces for inserting a GOV, inserting a blank GOV, inserting data of an incomplete GOV, reading out a GOV, and searching for a GOV; means for, when a speed of GOV reading is slower than a speed of GOV inserting, allowing overwriting an old unread GOV with resynchronization of read and write pointers by resetting a buffer status and dropping rest unread GOVs; means for verifying an incomplete GOV and sending a retransmission request corresponding to the verified incomplete GOV to the RTP/RTCP transport engine client module; means for recovering a complete GOV corresponding to the incomplete GOV from retransmitted data; and means for collecting a current buffer status as the bitrate control information and sending the bitrate control information to the bitrate adapter module in the client.

A sixth aspect of this invention is based on the first aspect thereof, and provides an MPEG-4 live unicast video streaming system wherein the RTP/RTCP transport engine client module comprises means for receiving the RTP packets by a UDP connection through the wireless network, and then desegmentizing and depacketizing the received RTP packets to each GOV; means for inserting one of an incomplete GOV and a blank GOV into the data link buffer in the client upon occurrence of one of packet loss and packet out-of-sequence; means for receiving the retransmission request from the data link buffer in the client, and then forwarding the retransmission request to the RTP/RTCP transport engine server module through a UDP connection which loads an RTCP packet with information representative of the retransmission request; means for, upon receiving the retransmitted data, searching the data link buffer in the client for a specified GOV; means for, when the specified GOV is found, inserting the retransmitted data or a whole GOV containing the retransmitted data into its position in the data link buffer in the client; and means for setting a forbidden-retransmission flag of the specified GOV in the data link buffer in the client to forbid a further retransmission request when a forbidden-retransmission RTCP packet is received.

A seventh aspect of this invention is based on the first aspect thereof, and provides an MPEG-4 live unicast video streaming system wherein the bitrate adapter module in the client comprises means for receiving the bitrate control information from the data link buffer in the client; means for making the bitrate control decision in response to the received bitrate control information; means for forwarding the bitrate control decision to the bitrate adapter module in the streaming server through a TCP connection; means for, according to the network bandwidth polling protocol, activating a polling process to work with the bitrate adapter module in the streaming server; and means for initiating an auto-negotiation on an initial streaming bitrate between the streaming server and the client to work with the bitrate adapter module in the streaming server by using the network bandwidth polling protocol.

An eighth aspect of this invention is based on the first aspect thereof, and provides an MPEG-4 live unicast video streaming system wherein each RTP packet has an extended structure including additional fields defined for depacketization and desegmentation.

A ninth aspect of this invention is based on the third aspect thereof, and provides an MPEG-4 live unicast video streaming system wherein the RTCP packet has a user application structure including additional fields defined for retransmission.

A tenth aspect of this invention is based on the first aspect thereof, and provides an MPEG-4 live unicast video streaming system wherein each of the data link buffer in the streaming server and the data link buffer in the client stores a GOV in one GOV node with related information.

An eleventh aspect of this invention is based on the first aspect thereof, and provides an MPEG-4 live unicast video streaming system further comprising a retransmission mechanism for retransmitting data from the streaming server to the client, the retransmission mechanism including the data link buffer in the client, the RTP/RTCP transport engine client module, and the RTP/RTCP transport engine server module.

A twelfth aspect of this invention is based on the first aspect thereof, and provides an MPEG-4 live unicast video streaming system further comprising means provided in the bitrate adapter module in the streaming server and the bitrate adapter module in the client for implementing the network bandwidth polling protocol.

A thirteenth aspect of this invention is based on the first aspect thereof, and provides an MPEG-4 live unicast video streaming system further comprising means provided in the data link buffer in the client, the bitrate adapter module in the streaming server, and the bitrate adapter module in the client for implementing the bitrate adaptation protocol.

A fourteenth aspect of this invention is based on the thirteenth aspect thereof, and provides an MPEG-4 live unicast video streaming system wherein the bitrate adaptation protocol includes a bitrate decision rule with implementation of a decision sliding window.

A fifteenth aspect of this invention provides an MPEG-4 live unicast video streaming system comprising an MPEG-4 encoder encoding an information signal into MPEG-4 data composed of successive GOVs at an adjustable encoding bitrate and outputting the GOVs, and adjusting the encoding bitrate in accordance with a bitrate control signal; a streaming server receiving the GOVs from the MPEG-4 encoder; first means provided in the streaming server for changing each received GOV into packets; second means provided in the streaming server for wirelessly transmitting the packets generated by the first means; a client wirelessly receiving the packets from the streaming server; third means provided in the client for changing the received packets into each recovered GOV; a buffer memory provided in the client for temporarily storing recovered GOVs generated by the third means; fourth means for reading out each GOV from the buffer memory; fifth means for calculating a remaining playback time corresponding to GOVs in the buffer memory which have not yet been read out by the fourth means; sixth means provided in the client for generating the bitrate control signal in response to the remaining playback time calculated by the fifth means; seventh means for wirelessly transmitting the bitrate control signal generated by the sixth means to the streaming server; and eighth means for transmitting the bitrate control signal from the streaming server to the MPEG-4 encoder.

A sixteenth aspect of this invention is based on the fifteenth aspect thereof, and provides an MPEG-4 live unicast video streaming system wherein the fourth means comprises an MPEG-4 decoder decoding each GOV read out from the buffer memory into a corresponding portion of an original information signal.

A seventeenth aspect of this invention is based on the fifteenth aspect thereof, and provides an MPEG-4 live unicast video streaming system further comprising ninth means for deciding whether or not each GOV in the buffer memory is short of data and requires absent data; tenth means for, when the ninth means decides that a GOV in the buffer memory is short of data and requires absent data, generating a retransmission packet loaded with the absent data in the streaming server; eleventh means for wirelessly transmitting the retransmission packet from the streaming server to the client; twelfth means provided in the client for extracting the absent data from the retransmission packet; and thirteenth means provided in the client for inserting the absent data extracted by the twelfth means into the data-short GOV in the buffer memory.

### BRIEF DESCRIPTION OF THE DRAWINGS

FIG. 1 is a block diagram of an MPEG-4 live unicast video streaming system according to a specific embodiment of this invention.

FIG. 2 is a diagram of the system in FIG. 1.

FIG. 3 is a diagram showing the overview of an RTSP session procedure.

FIG. 4 is a diagram showing the overview of an RTP/RTCP transport engine server and an RTP/RTCP transport engine client in FIG. 2.

FIG. 5 is a diagram showing the overview of normal data transmission between the RTP/RTCP transport engine server and the RTP/RTCP transport engine client.

FIG. 6 is a diagram showing the overview of data retransmission between the RTP/RTCP transport engine server and the RTP/RTCP transport engine client.

FIG. 7 is a diagram showing the structure of an extended RTP packet.

FIG. 8 is a diagram showing a table of fields in the extended RTP packet.

FIG. 9 is a diagram showing the structure of a user application RTCP packet.

FIG. 10 is a diagram showing a table of fields in the user application RTCP packet.

FIG. 11 is an operation flowchart schematically showing the processing operation of the RTP/RTCP transport engine server.

FIG. 12 is a diagram showing the structure of a complete GOV with RG (RTP GOV).

FIG. 13 is a diagram showing the classification of three different RGs regarding a UDP out-of-sequence problem.

FIG. 14 is an operation flow diagram showing the processing operation of the RTP/RTCP transport engine client.

FIG. 15 is an operation flow diagram listing the main different processes of the RTP/RTCP transport engine client upon the reception of an RTP packet.

FIG. 16 is a flowchart showing the process of GOV insertion into a data link buffer within a client in FIGS. 1 and 2.

FIG. 17 is a flowchart of the details of a block in FIG. 16.

FIG. 18 is a flowchart showing the process of GOV reading from the data link buffer within the client in FIGS. 1 and 2.

FIG. 19 is a flowchart of the details of a block in FIG. 18.

FIG. 20 is a time sequence diagram showing bitrate control message flows in the system of FIGS. 1 and 2.

FIG. 21 is a time sequence diagram showing retransmission message flows in the system of FIGS. 1 and 2.

FIG. 22 is a flowchart showing the process of making a bitrate control decision in the client in FIGS. 1 and 2.

FIG. 23 is a diagram showing the basic definitions of a bitrate control mechanism in the system of FIGS. 1 and 2.

FIG. 24 is a diagram showing a normal playback scenario of the bitrate control mechanism.

FIG. 25 is a diagram showing a network deterioration scenario of the bitrate control mechanism.

FIG. 26 is a diagram showing a decoder's poor throughput scenario of the bitrate control mechanism.

FIG. 27 is a time sequence diagram showing a polling process in the system of FIGS. 1 and 2.

FIG. 28 is a flowchart showing an auto-negotiation procedure in the system of FIGS. 1 and 2.

### DETAILED DESCRIPTION OF THE INVENTION

### Basic Embodiment

Communications between a client and a server are in two ways, that is, an uplink and a downlink. The downlink is a streaming channel, and adopts UDP (user datagram protocol, RFC768). The uplink is a messaging channel, and adopts TCP (transmission control protocol, RFC793).

According to a basic embodiment of this invention, an architecture of transporting MPEG-4 simple profile video data includes a rate adaptive MPEG-4 simple profile encoder, a LAN (local area network), a streaming server, a rate adaptive MPEG-4 simple profile decoder, and a client.

The rate adaptive MPEG-4 simple profile encoder generates MPEG-4 simple profile live video data through an encoding procedure with an adjustable encoding bitrate. The rate adaptive MPEG-4 simple profile encoder pushes the generated live video data to the streaming server through the LAN. The rate adaptive MPEG-4 simple profile encoder adjusts the encoding bitrate in accordance with a request (bitrate control request) from the streaming server.

The LAN connects the rate adaptive MPEG-4 simple profile encoder and the streaming server.

The streaming server has a data receiver module to receive MPEG-4 simple profile live video data from the rate adaptive MPEG-4 simple profile encoder through the LAN. The streaming server has an RTSP (real-time streaming protocol, RFC2326) server module which performs session control. The streaming server has a data transmission module constituting an RTP/RTCP (real-time transport protocol/real-time control protocol) transport engine server. The data transmission module segmentizes the MPEG-4 simple profile live video data on the boundary of GOV (group of video object planes). The data transmission module packetizes each GOV as the payload of RTP (real-time transport protocol, RFC1889) packets, and pushes those RTP packets to the client through a wireless network according to each GOV data bitrate, whereas RTCP (real-time control protocol, RFC1889) is implemented to receive a retransmission request. Specifically, one RTP packet is packed as the payload of one UDP packet. The RTP packets transmitted from the streaming server to the client are carried by respective UDP packets. These UDP packets are also referred to as the RTP/UDP packets. The wireless network includes the Internet. The streaming server has a bitrate adapter module. The bitrate adapter module implements a bitrate adaptation protocol and a network bandwidth polling protocol to allow the streaming server to receive feedback information from the client and make a decision on bitrate control that is to be forwarded to the rate adaptive MPEG-4 simple profile encoder as the bitrate control request. The streaming server has a data link buffer which stores the GOV data (the MPEG-4 simple profile live video data) that is received from the rate adaptive MPEG-4 simple profile encoder.

The rate adaptive MPEG-4 simple profile decoder resides in a client application. The rate adaptive MPEG-4 simple profile decoder operates to decode MPEG-4 simple profile live video data to get decoded pictures. The rate adaptive MPEG-4 simple profile decoder renders the decoded pictures.

The client receives the MPEG-4 simple profile live video data from the streaming server through the wireless network. As previously mentioned, the wireless network includes the Internet. The client has an RTSP (real-time streaming protocol, RFC2326) client module which performs session control. The client has a data transmission module constituting an RTP/RTCP (real-time transport protocol/real-time control protocol) transport engine client. The data transmission module receives the RTP (real-time transport protocol, RFC1889) packets from the streaming server through the wireless network (Internet). The data transmission module depacketizes MPEG-4 data blocks from the payload of the received RTP packets, and desegmentizes the MPEG-4 data blocks back to an original GOV (group of video object planes) referred to as a recovered GOV. The data transmission module reconstructs an MPEG-4 video stream composed of recovered GOVs, whereas RTCP (real-time control protocol, RFC1889) is implemented to send the retransmission request. The client has a bitrate adapter module. The bitrate adapter module implements the bitrate adaptation protocol and the network bandwidth polling protocol to feedback bitrate control information to the streaming server. The bitrate adapter module in the client and that in the streaming server are counterparts with respect to each other. The client has a data link buffer which stores the GOV data (the reconstructed MPEG-4 video stream) and monitors the buffering status of itself as well as forwards the collected buffer state information to the bitrate adapter module.

According to the basic embodiment of this invention, the initial streaming bitrate is decided by two ways (1) and (2) as follows.

(1) Manually configured at the client by the user through a GUI (graphic user interface); and

(2) Auto-negotiated by the streaming server and the client with the network bandwidth polling protocol.

According to the basic embodiment of this invention, the bitrate adaptation to the available network bandwidth consists of two aspects (1) and (2) as follows.

(1) Decrease of the encoding bitrate due to network deterioration or decoder's poor throughput; and

(2) Increase of the encoding bitrate due to health network condition.

The MPEG-4 simple profile live video data generated by the rate adaptive MPEG-4 simple profile encoder takes the form of a bit stream. Preferably, the generated bit stream is firstly sent to the streaming server through an HTTP/TCP connection on a GOV-by-GOV basis. In this case, the data transmission module in the streaming server is allowed to segmentize and packetize the GOVs before the GOVs are put on the wireless network according to their bitrates.

Preferably, if the data transmission module in the client receives the incoming RTP packets (RTP/UDP packets), it starts the reconstruction of each GOV, in other words, each access unit. Then, the recovered GOV is inserted into the data link buffer in the client.

Preferably, if a packet loss occurs during the transmission of RTP/UDP packets, at least one blank GOV or at least one partially recovered GOV is inserted into the data link buffer in the client.

Preferably, the data link buffer in the client checks whether it is necessary to retransmit a GOV or a part of a GOV. The retransmission checking is triggered by the insertion of a fully recovered GOV. The data link buffer generates retransmission requests in accordance with the results of the retransmission checking. The retransmission requests are passed from the data link buffer to the data transmission module in the client, and are then transmitted to the streaming server by RTCP/UDP packets propagating through the wireless network. In this case, it is desirable to try the retransmission of a GOV or a part of a GOV only once. Only GOVs that are still in the data link buffer within the streaming server can be retransmitted.

It is preferable that the adaptive rate MPEG-4 simple profile decoder takes fully recovered GOVs, including ones recovered by retransmission, from the data link buffer in the client.

Preferably, the data link buffer in the client collects its own current status and forwards that information to the bitrate adapter module in the client. This action is triggered each time the adaptive rate MPEG-4 simple profile decoder successfully takes out of a GOV from the data link buffer.

Preferably, the bitrate adapter module in the client evaluates the bitrate control information in response to the information given by the data link buffer, and then forwards the evaluated bitrate control information to its counterpart in the streaming server through a TCP connection.

It is preferable that the bitrate adapter module in the streaming server makes a decision on bitrate adjustment based on the information from its counterpart in the client. The bitrate adapter module generates a corresponding command in accordance with the result of the bitrate adjustment decision. The generated command is sent from the bitrate adapter module to the adaptive rate MPEG-4 simple profile encoder to adjust the next GOV's encoding bitrate.

It is preferable that the bitrate adapter module in the client and its counterpart in the streaming server negotiate the initial streaming bitrate using the network bandwidth polling protocol by temporarily opening a UDP connection. In this case, the network bandwidth polling process can be triggered by a polling timer during the data streaming procedure. The bitrate adapter module in the client and its counterpart in the streaming server negotiate how far the current network bandwidth is over the current streaming bitrate by temporarily opening a UDP connection.

Preferably, the user is allowed to control the streaming session through a GUI (graphic user interface). Related commands such as “start” and “stop” are generated in accordance with user's requests, and are then transported from the RTSP client module in the client to the RTSP server module in the streaming server by an RTSP/TCP connection.

### Specific Embodiment

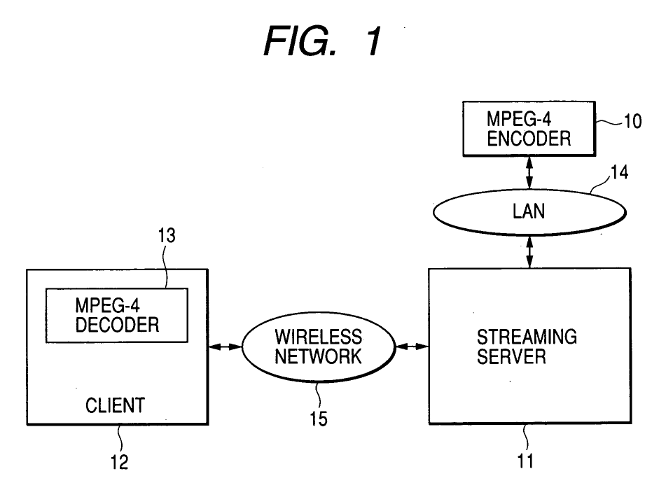

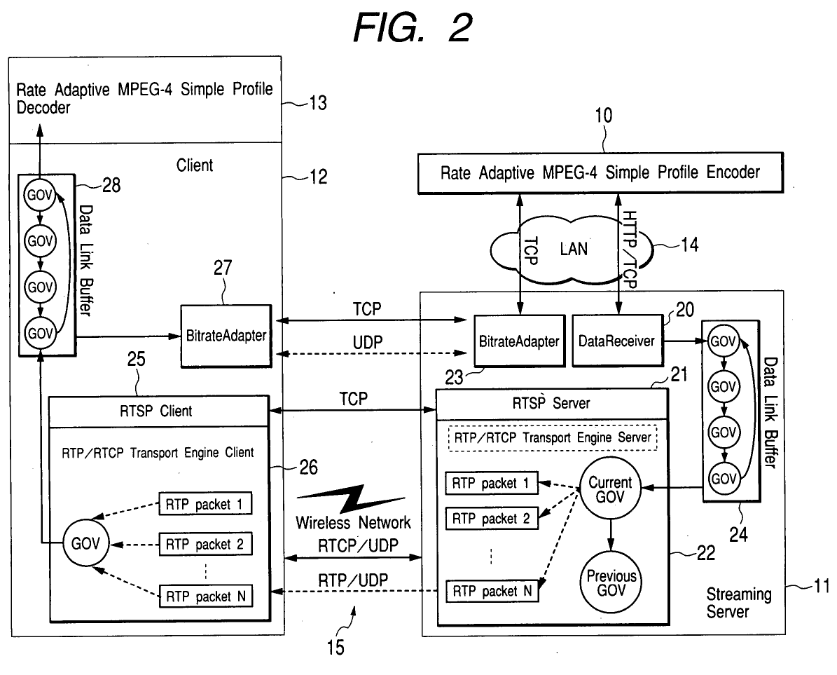

FIGS. 1 and 2 show an MPEG-4 live unicast video streaming system according to a specific embodiment of this invention. The MPEG-4 live unicast video streaming system is provided with end-to-end congestion control. With reference to FIGS. 1 and 2, the MPEG-4 live unicast video streaming system includes a rate adaptive MPEG-4 simple profile encoder (MPEG-4 encoder) 10, a streaming server 11, and a client 12. The client 12 contains a rate adaptive MPEG-4 simple profile decoder (MPEG-4 decoder) 13.

Preferably, the streaming server 11, the client 12, and the MPEG-4 encoder 10 use information-processing devices that can execute the processes described below. Those information-processing devices include general-purpose computers, workstations, and personal computers, as well as network connectable information-processing devices such as digital home electric appliances, portable terminals such as PDAs, and cellular phones. It should be noted that the processes described below may be performed by a software product and that a part of the processes may be done on a hardware unit.

The MPEG-4 encoder 10 and the streaming server 11 are connected via a LAN 14. The MPEG-4 encoder 10 and the streaming server 11 can communicate with each other via the LAN 14. The MPEG-4 encoder 10 includes a LAN interface for connection with the LAN 14, The streaming server 11 includes a LAN interface for connection with the LAN 14.

The streaming server 11 and the client 12 are connected via a wireless network 15 including the Internet. The streaming server 11 and the client 12 can communicate with each other via the wireless network 15. The streaming server 11 contains a wireless communication interface for connection with the wireless network 15. The client 12 contains a wireless communication interface for connection with the wireless network 15.

The MPEG-4 encoder 10 encodes audio visual data into data of the MPEG-4 format that is referred to as MPEG-4 data. The MPEG-4 encoder 10 sends the MPEG-4 data to the streaming server 11 via the LAN 14. The streaming server 11 receives the MPEG-4 data from the MPEG-4 encoder 10. The streaming server 11 sends the MPEG-4 data to the client 12 via the wireless network 15. The client 12 receives the MPEG-4 data from the streaming server 11. The MPEG-4 decoder 13 in the client 12 decodes the received MPEG-4 data into original audio visual data (recovered audio visual data). Preferably, the client 12 includes a display for indicating the visual contents of the recovered audio visual data, and loudspeakers for converting the audio contents of the recovered audio visual data into corresponding sounds.

Preferably, the streaming server 11 includes a computer connected with the LAN interface and the wireless communication interface therein. The computer has a combination of an input/output port, a CPU, a ROM, and a RAM. The computer operates in accordance with a control program stored in the ROM or the RAM. The streaming server 11 may further include a storage unit such as a hard disk drive unit. In this case, the control program for the computer may be stored in the storage unit. The control program for the computer is designed so that the streaming server 11 can execute operation steps mentioned hereafter and will be virtually provided with different functional devices or modules mentioned later.

Preferably, the client 12 includes a computer connected with the wireless communication interface, the display, and the loudspeakers therein. The computer has a combination of an input/output port, a CPU, a ROM, and a RAM. The computer operates in accordance with a control program stored in the ROM or the RAM. The client 12 may further include a storage unit such as a hard disk drive unit. In this case, the control program for the computer may be stored in the storage unit. The control program for the computer is designed so that the client 12 can execute operation steps mentioned hereafter and will be virtually provided with different functional devices or modules mentioned later. Generally, the client 12 includes a user interface connected with the computer therein. The user interface can be operated by the user. The user can communicate with the client 12 via the user interface on a GUI (graphic user interface) basis.

Communications between the client 12 and the streaming server 11 are in two ways, that is, an uplink and a downlink. The downlink is a streaming channel, and adopts UDP (user datagram protocol, RFC768). The uplink is a messaging channel, and adopts TCP (transmission control protocol, RFC793).

The MPEG-4 encoder 10 generates MPEG-4 simple profile live video data through an encoding procedure with an adjustable encoding bitrate. The MPEG-4 encoder 10 pushes the generated live video data to the streaming server 11 through the LAN 14. The MPEG-4 encoder 10 includes a controller which adjusts the encoding bitrate in accordance with a request or a command (bitrate control information) from the streaming server 11.

The streaming server 11 has a data receiver module 20 to receive MPEG-4 simple profile live video data from the MPEG-4 encoder 10 through the LAN 14. The streaming server 11 has an RTSP (real-time streaming protocol, RFC2326) server module 21 which performs session control. The streaming server 11 has a data transmission module 22 constituting an RTP/RTCP (real-time transport protocol/real-time control protocol) transport engine server. The data transmission module 22 segmentizes the MPEG-4 simple profile live video data on the boundary of GOV (group of video object planes). The data transmission module 22 packetizes each GOV as the payload of RTP (real-time transport protocol, RFC1889) packets, and pushes those RTP packets to the client 12 through the wireless network 15 according to each GOV data bitrate, whereas RTCP (real-time control protocol, RFC1889) is implemented to receive a retransmission request. Specifically, one RTP packet is packed as the payload of one UDP packet. The RTP packets transmitted from the streaming server 11 to the client 12 are carried by respective UDP packets. These UDP packets are also referred to as the RTP/UDP packets. The streaming server 11 has a bitrate adapter module 23. The bitrate adapter module 23 implements a bitrate adaptation protocol and a network bandwidth polling protocol to allow the streaming server 11 to receive feedback information from the client 12 and make a decision on bitrate control that is to be forwarded to the MPEG-4 encoder 10 as the bitrate control request or the bitrate control command. The streaming server 11 has a data link buffer 24 connected between the data receiver module 20 and the data transmission module 22. The data link buffer 24 stores the GOV data (the MPEG-4 simple profile live video data) that is received from the MPEG-4 encoder 10 by the data receiver module 20.

The client 12 receives the MPEG-4 simple profile live video data from the streaming server 11 through the wireless network 15. The client has an RTSP (real-time streaming protocol, RFC2326) client module 25 which performs session control. The RTSP client module 25 in the client 12 and the RTSP server module 21 in the streaming server 11 are counterparts with respect to each other. The client 12 has a data transmission module 26 constituting an RTP/RTCP (real-time transport protocol/real-time control protocol) transport engine client. The data transmission module 26 receives the RTP (real-time transport protocol, RFC1889) packets from the streaming server 11 through the wireless network 15. The data transmission module 26 depacketizes MPEG-4 data blocks from the payload of the received RTP packets, and desegmentizes the MPEG-4 data blocks back to an original GOV (group of video object planes) referred to as a recovered GOV. The data transmission module 26 reconstructs an MPEG-4 video stream composed of recovered GOVs, whereas RTCP (real-time control protocol, RFC1889) is implemented to send the retransmission request. The client 12 has a bitrate adapter module 27. The bitrate adapter module 27 implements the bitrate adaptation protocol and the network bandwidth polling protocol to feedback bitrate control information to the streaming server 11. The bitrate adapter module 27 in the client 12 and the bitrate adapter module 23 in the streaming server 11 are counterparts with respect to each other. The client 12 has a data link buffer 28 connected among the data transmission module 26, the bitrate adapter module 27, and the MPEG-4 decoder 13. The data link buffer 28 stores the GOV data (the reconstructed MPEG-4 video stream) and monitors the buffering status of itself as well as forwards the collected buffer state information to the bitrate adapter module 27 as the bitrate control information.

The initial streaming bitrate is decided by two ways (1) and (2) as follows.

(1) Manually configured at the client 12 by the user through a GUI (graphic user interface); and

(2) Auto-negotiated by the streaming server 11 and the client 12 with the network bandwidth polling protocol.

The bitrate adaptation to the available network bandwidth consists of two aspects (1) and (2) as follows.

(1) Decrease of the encoding bitrate due to network deterioration or decoder's poor throughput; and

(2) Increase of the encoding bitrate due to health network condition.

The MPEG-4 simple profile live video data generated by the MPEG-4 encoder 10 takes the form of a bit stream. Preferably, the generated bit stream is firstly sent to the streaming server 11 through an HTTP/TCP connection using the LAN 14 on a GOV-by-GOV basis. In this case, the data transmission module 22 in the streaming server 11 is allowed to segmentize and packetize the GOVs before the GOVs are put on the wireless network 15 according to their bitrates.

When the data transmission module 26 in the client 12 receives the incoming RTP packets (RTP/UDP packets), it starts the reconstruction of each GOV, in other words, each access unit. Then, the data transmission module 26 inserts the recovered GOV into the data link buffer 28 in the client 12.

In the event that a packet loss occurs during the transmission of RTP/UDP packets, the data transmission module 26 in the client 12 inserts at least one blank GOV or at least one partially recovered GOV into the data link buffer 28 in the client 12.

The data link buffer 28 in the client 12 checks whether it is necessary to retransmit a GOV or a part of a GOV. The retransmission checking is triggered by the insertion of a fully recovered GOV. The data link buffer 28 generates retransmission requests in accordance with the results of the retransmission checking. The retransmission requests are passed from the data link buffer 28 to the data transmission module 26 in the client 12, and are then transmitted to the streaming server 11 by RTCP/UDP packets propagating through the wireless network 15. In this case, it is desirable to try the retransmission of a GOV or a part of a GOV only once. Only GOVs that are still in the data link buffer 24 within the streaming server 11 can be retransmitted.

The MPEG-4 decoder 13 takes fully recovered GOVs, including ones recovered by retransmission, from the data link buffer 28 in the client 12.

In the client 12, the data link buffer 28 collects its own current status and forwards that information to the bitrate adapter module 27. This action is triggered each time the MPEG-4 decoder 13 successfully takes out of a GOV from the data link buffer 12.

The bitrate adapter module 27 in the client 12 evaluates the bitrate control information in response to the information given by the data link buffer 28, and then forwards the evaluated bitrate control information to the bitrate adapter module 23 in the streaming server 11 through a TCP connection using the wireless network 15.

The bitrate adapter module 23 in the streaming server 11 makes a decision on bitrate adjustment based on the bitrate control information from the bitrate adapter module 27 in the client 12. The bitrate adapter module 23 generates a corresponding command in accordance with the result of the bitrate adjustment decision. The generated command is sent from the bitrate adapter module 23 to the MPEG-4 encoder 10 via the LAN 14. The controller in the MPEG-4 encoder 10 adjusts the next GOV's encoding bitrate in accordance with the command from the bitrate adapter module 23 within the streaming server 11.

The bitrate adapter module 27 in the client 12 and the bitrate adapter module 23 in the streaming server 11 negotiate the initial streaming bitrate using the network bandwidth polling protocol by temporarily opening a UDP connection via the wireless network 15. In this case, the network bandwidth polling process can be triggered by a polling timer during the data streaming procedure. The bitrate adapter module 27 in the client 12 and the bitrate adapter module 23 in the streaming server 11 negotiate how far the current network bandwidth is over the current streaming bitrate by temporarily opening a UDP connection via the wireless network 15.

The user is allowed to control the streaming session through a GUI. The client 12 generates related commands such as “start” and “stop” in accordance with user's requests. The generated commands are transported from the RTSP client module 25 in the client 12 to the RTSP server module 21 in the streaming server 11 by an RTSP/TCP connection using the wireless network 15.

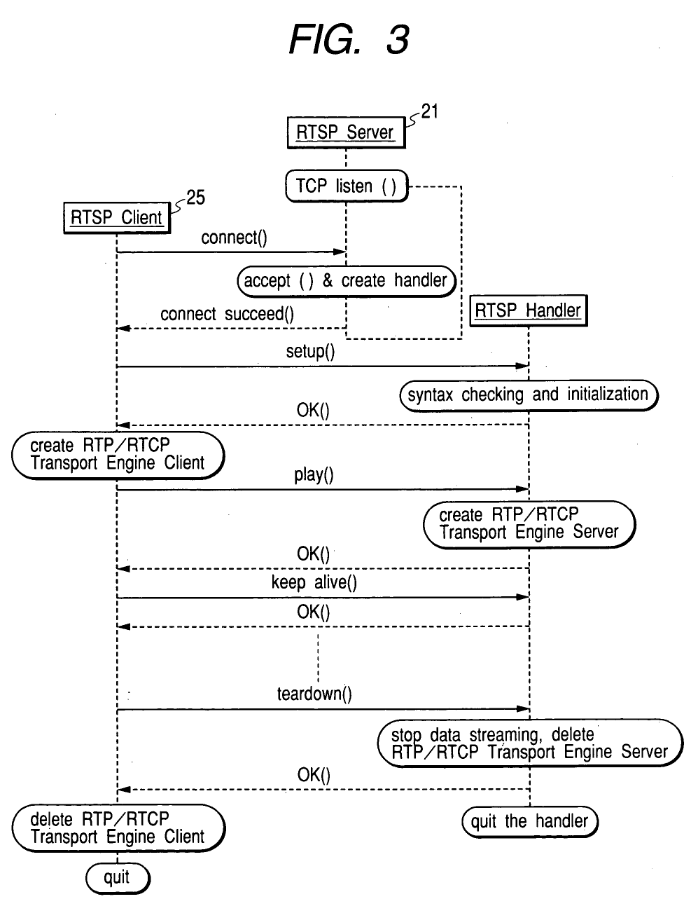

FIG. 3 schematically shows the overview of the session procedure of RTSP. With reference to FIG. 3, the RTSP session procedure between the streaming server 11 and the client 12 fully conforms to RFC2326 with the following messages.

Set up the session
Client -> Streaming Server
SETUP rtsp://Server_Addr.Port_Num/Content_ID/User_ID RTSP/1.0
Cseq: Sequence_Num
Transport: RTP/AVP; unicast; client_port=RTP_Port-RTCP_Port
Streaming Server -> Client
RTSP/1.0 200 OK
Cseq: Sequence_Num
Session: Session_Num
Transport: RTP/AVP; unicast; server_port=RTP_Port-RTCP_Port
Start to play
Client -> Streaming Server
PLAY rtsp://Server_Addr.Port_Num/Content_ID/User_ID RTSP/1.0
Cseq: Sequence_Num
Session: Session_Num
Streaming Server -> Client
RTSP/1.0 200 OK
Cseq: Sequence_Num
Session: Session_Num
Range: npt=Start_Time-End_Time
Stop the play and tear down the connection
Client -> Streaming Server

| | |
|---|---|
| TEARDOWN rtsp: | //Server_Addr.Port_Num/Content_ID/User_ID |
| | RTSP/1.0 |

Cseq: Sequence_Num
Session: Session_Num
Streaming Server -> Client
RTSP/1.0 200 OK
Cseq: Sequence_Num
Session: Session_Num
Keep alive message
Client -> Streaming Server

| | |
|---|---|
| GET_PARAMETER rtsp: | //Server_Addr.Port_Num/Content_ID/ |
| | User_ID RTSP/1.0 |

Cseq: Sequence_Num
Session: Session_Num
Streaming Server -> Client
RTSP/1.0 200 OK
Cseq: Sequence_Num
Session: Session_Num

The RTSP client module 25 initially sends the setup message to the RTSP server module 21 via the wireless network 15 to ask for a session setup. When the RTSP client module 25 gets an active ACK (acknowledgment), it creates the object of the RTP/RTCP transport engine client 26 and sends the play message to the RTSP server module 21 via the wireless network 15 to ask for start of the streaming. The RTSP server module 21 then controls the RTP/RTCP transport engine server 22 to provide the streaming service. During the session, both the RTSP server module 21 and the RTSP client module 25 sense the counterpart's statuses by exchanging GET_PARAMETER messages via the wireless network 15. The GET_PARAMETER messages act as keep-alive messages. At the end of the session, the RTSP client module 25 sends the tear-down message to the RTSP server module 21. The RTSP server module 21 terminates the session in accordance with the tear-down message.

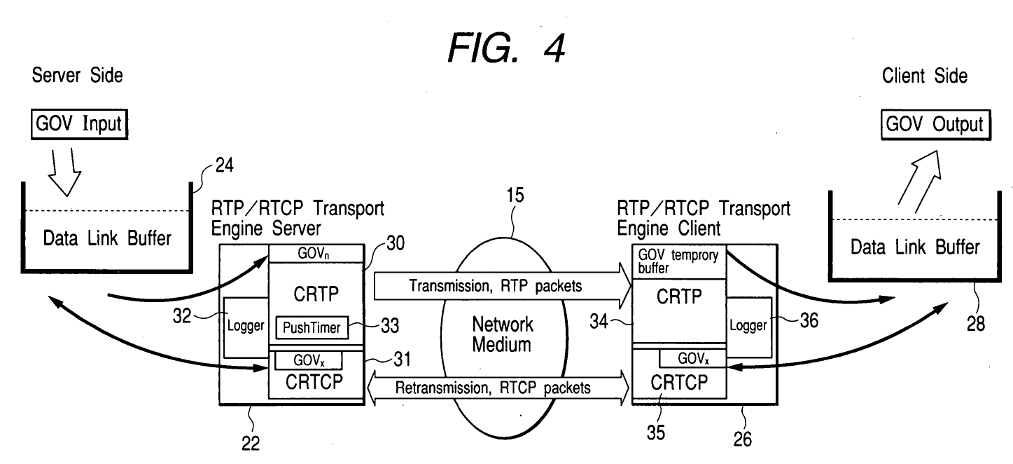

FIG. 4 schematically shows the overview of the RTP/RTCP transport engine server 22 and the RTP/RTCP transport engine client 26. With reference to FIGS. 2 and 4, the data link buffer 24 at the streaming server 11 and the data link buffer 28 at the client 12 act to facilitate the recovery of packet losses and ensure the constant flow of GOV data to the MPEG-4 decoder 13. At the streaming server 11, the RTP/RTCP transport engine server 22 gets the MPEG-4 data from the data link buffer 24 on a GOV-by-GOV basis. A GOV is firstly fragmented and encapsulated into RTP packets by the RTP/RTCP transport engine server 22. Then, the RTP packets are sent from the RTP/RTCP transport engine server 22 to the client 12. At the client 12, the RTP/RTCP transport engine client 26 receives the RTP packets. The RTP/RTCP transport engine client 26 extracts the GOV RTP data from the RTP packets and assembles them into a GOV. Then, the RTP/RTCP transport engine client 26 inserts the GOV into the data link buffer 28.

The data link buffer 24 in the streaming server 11 stores GOVs of MPEG-4 data for transmission and retransmission. The RTP/RTCP transport engine server 22 handles the transmission/retransmission of GOV data. The RTP/RTCP transport engine server 22 includes a CRTP section 30, a CRTCP section 31, a logger 32, and a push timer 33. The CRTP section 30 constructs the RTP header from the related GOV information. The CRTP section 30 handles an RTP/UDP connection. The CRTP section 30 also handles packet transmission and packet retransmission. The CRTCP section 31 receives a retransmission request. The CRTCP section 31 replies any retransmission-forbidden notice. The logger 32 records every packet transmission timing, and logs error information. The push timer 33 controls the streaming bitrate.

The data link buffer 28 in the client 12 stores GOVs that are fed from the RTP/RTCP transport engine client 26. The data link buffer 28 passes the GOVs to the MPEG-4 decoder 13. The RTP/RTCP transport engine client 26 handles GOV data receiving. The RTP/RTCP transport engine client 26 has a CRTP section 34, a CRTCP section 35, and a logger 36. The CRTP section 34 handles an RTP/UDP connection and data receiving. The CRTP section 34 interprets every RTP header and extracts RTP payload data. The CRTP section 34 reconstructs each GOV from the extracted RTP payload data. The CRTCP section 35 sends out a retransmission request. The CRTCP section 35 receives any retransmission-forbidden notice. The logger 36 records every RTP packet arrival timing, and logs error information.

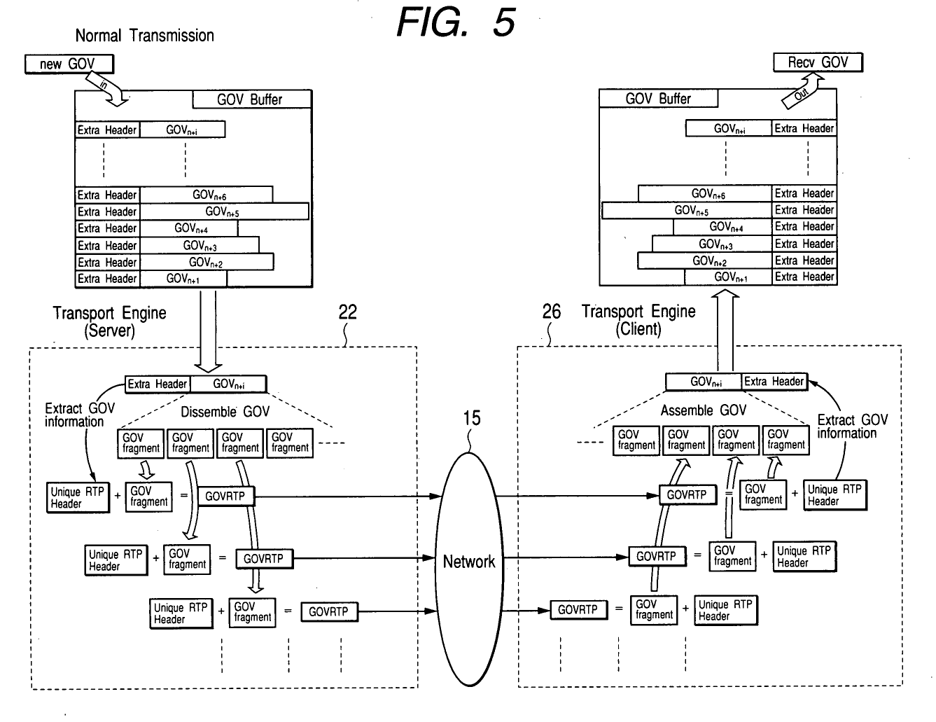

FIG. 5 schematically shows the overview of the normal data transmission between the RTP/RTCP transport engine server 22 and the RTP/RTCP transport engine client 26. With reference to FIGS. 2 and 5, at the streaming server 11, each raw GOV fed from the MPEG-4 encoder 10 is inserted into the data link buffer 24 with related information such as a GOV bitrate, a GOV duration, and a GOV size. In the data link buffer 24, a new memory node is allocated to store the newly inserted GOV with its related information. The RTP/RTCP transport engine server 22 takes one GOV node from the data link buffer 24. The RTP/RTCP transport engine server 22 calculates the RTP packet duration according to the GOV bitrate, the GOV size, and the RTP packet size. The RTP/RTCP transport engine server 22 sets the push timer 33 in response to the calculated RTP packet duration. When the push timer 33 triggers, an extended RTP packet (a fragment of GOV) is sent from the RTP/RTCP transport engine server 22 to the client 12. The RTP/RTCP transport engine server 22 dispatches RTP packets at intervals decided by a msec timer according to the GOV bitrate. The msec timer is provided by the push timer 33.

At the client 12, the RTP/RTCP transport engine client 26 receives RTP packets containing GOV data. The RTP/RTCP transport engine client 26 tries to reconstruct the GOV. The RTP/RTCP transport engine client 26 inserts the successfully recovered GOV into the data link buffer 28. The data link buffer 28 checks for any GOV that needs to be retransmitted wholly or partially, and generates a corresponding request (retransmission request). The data link buffer 28 feeds the retransmission request to the RTP/RTCP transport engine client 26. Retransmission requests are transmitted between the RTP/RTCP transport engine client 26 and the RTP/RTCP transport engine server 22.

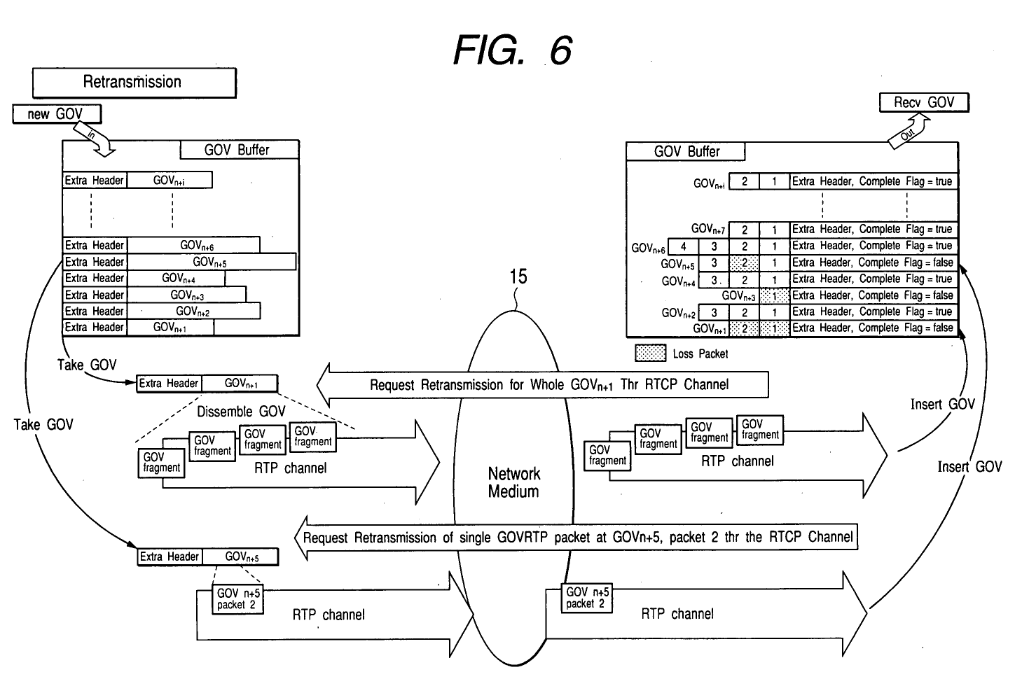

FIG. 6 schematically shows the overview of the data retransmission between the RTP/RTCP transport engine server 22 and the RTP/RTCP transport engine client 26. In general, there are two types of retransmission, that is, the retransmission of a single RTP packet and the retransmission of a whole GOV. The corresponding requests (retransmission requests) are handled by the CRTCP sections 31 and 35, which realize the RTCP protocol. In each retransmission request, the GOV sequence number and its RTP packet sequence number are defined as the fields of an RTCP packet (a user application RTCP packet). Upon receiving such an RTCP request, the streaming server 11 will try to retrieve the designated GOV from the data link buffer 24 as long as the designated GOV is still there without being overwritten by a new GOV. For an RTCP request for a whole GOV, the streaming server 11 will try to push the designated GOV to the client 12 as soon as possible in multiple RTP packets. For an RTCP request for a single RTP packet, the streaming server 11 takes out the corresponding chunk of data to the client 12 in one RTP packet as soon as possible. In the event that multiple RTP packets of one GOV are lost, the retransmission requests of those RTP packets will be issued one by one. In the case where the designated GOV is no longer existing in the data link buffer 24, that is, in the case where the designated GOV has been overwritten by a new GOV, the streaming server 11 will reply a retransmission-forbidden message to the client 12 through an RTCP packet. Once the client 12 receives such a reply, it marks up the corresponding GOV in the data link buffer 28 with a retransmission-forbidden flag indicating that retransmission is failed and no retransmission request should be re-issued. A retransmission RTP packet is processed as same as a normal RTP packet is. The retransmitted data will be inserted into the corresponding GOV in the data link buffer 28 as long as it is still waiting for the decoder's taking out. The data link buffer 28 checks for any GOVs needing to be retransmitted. The checking process is triggered by the insertion of a new fully recovered GOV. Furthermore, in order not to affect the normal transmission too much, it is preferable to limit the number of retransmission requests for the same GOV data to less than a predetermined number in the case where a retransmission packet is repetitively lost. The predetermined number corresponds to, for example, n times (a predetermined number of times). This limitation is introduced also since retransmission will consume the network bandwidth.

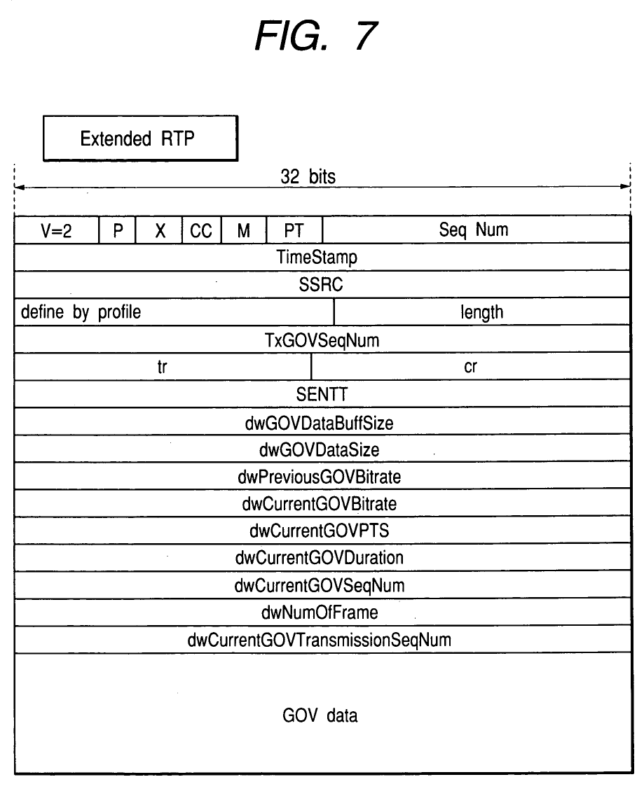

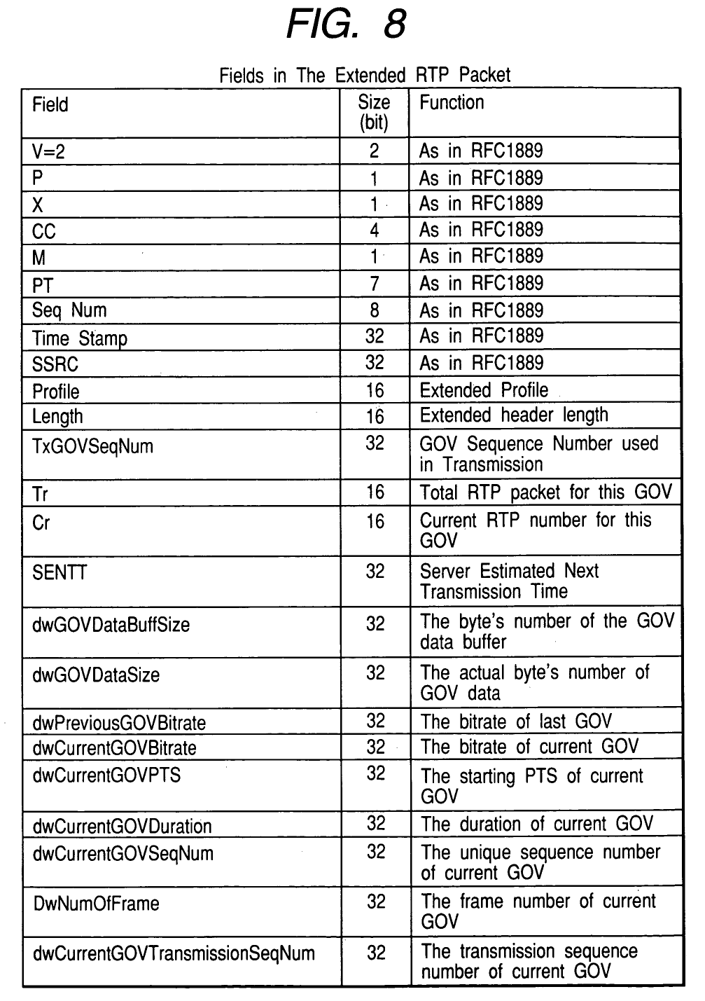

FIG. 7 shows the structure of the extended RTP packet. The extended RTP packet results from extension with several additional header fields to facilitate packetizing and depacketizing the GOV. All the fields in the extended RTP packet have contents as shown in FIG. 8.

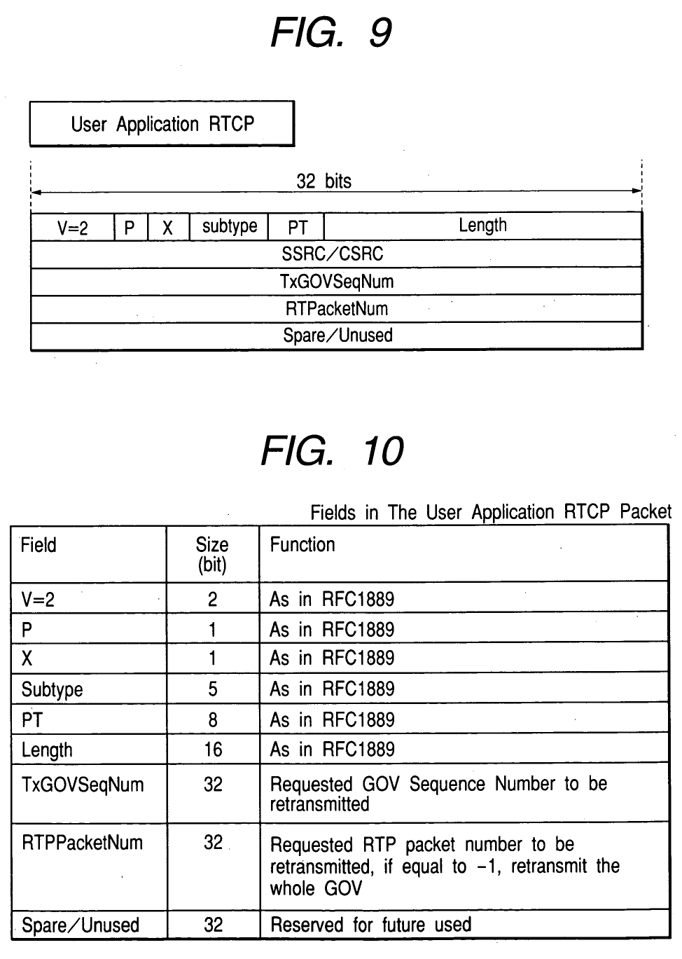

FIG. 9 shows the structure of the user application RTCP packet. The user application RTCP packet is used to send the retransmission request for a lost RTP packet. All the fields in the user application RTCP packet have contents as shown in FIG. 10.

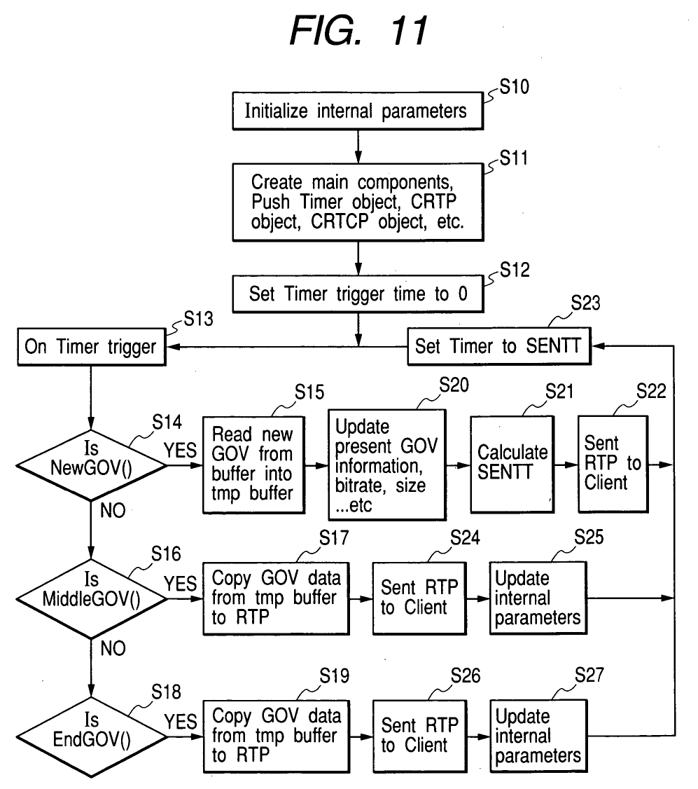

FIG. 11 is an operation flowchart schematically showing the processing operation of the RTP/RTCP transport engine server 22 which is implemented according to the corresponding segment of the control program for the computer in the streaming server 11. The RTP/RTCP transport engine server 22 is responsible for segmentizing and packetizing each GOV into RTP packets, and pushing those RTP packets to the client 12 through the wireless network 15.

With reference to FIG. 11, a first step S10 initializes internal parameters. A step S11 following the step S10 creates main components such as a push timer object, a CRTP object, and CRTCP object. A step S12 subsequent to the step S11 sets a timer trigger time to 0. The step S12 is followed by a step S13.

The step S13 activates a timer. Specifically, the step S13 triggers an on-time of the timer. Accordingly, the step 13 corresponds to the moment when the timer is activated. A step S14 following the step S13 decides whether or not a new GOV fragment (the first fragment of a GOV) should be processed. When a new GOV fragment should be processed, the step S14 is followed by a step S15. Otherwise, the step S14 is followed by a step S16.

The step S16 decides whether or not a middle GOV fragment (a middle fragment of a GOV) should be processed. When a middle GOV fragment should be processed, the step S16 is followed by a step S17. Otherwise, the step S16 is followed by a step S18.

The step S18 decides whether or not a last GOV fragment (the last fragment of a GOV) should be processed. When a last GOV fragment should be processed, the step S18 is followed by a step S19. Otherwise, it is preferable to make a return from the step S18 to the step S16.

The step S15 reads a new GOV from the data link buffer 24 into a temporary buffer within the RTP/RTCP transport engine server 22. A step S20 following the step S15 updates the present GOV information such as the present GOV bitrate, the present GOV size, and the present GOV duration. A step S21 subsequent to the step S20 calculates a time value SENTT from, for example, the updated GOV information (the present GOV bitrate, the present GOV size, and the present GOV duration). The time value SENTT denotes an estimated length of time for the streaming server 11 to transmit a next RTP packet. A step S22 following the step S21 copies GOV first-fragment data from the temporary buffer to an RTP packet, and sends the RTP packet to the client 12. The step S22 is followed by a step S23.

The step S17 copies GOV middle-segment data from the temporary buffer to an RTP packet. A step S24 following the step S17 sends the RTP packet to the client 12. A step S25 subsequent to the step S24 updates the internal parameters. The step S25 is followed by the step S23.

The step S19 copies GOV last-segment data from the temporary buffer to an RTP packet. A step S26 following the step S19 sends the RTP packet to the client 12. A step S27 subsequent to the step S26 updates the internal parameters. The step S27 is followed by the step S23.

The step S23 sets the on-time of the timer to the time value SENTT. The step S23 is followed by the step S13.

At the client 12, RTP packets (RTP/UDP packets) that contain GOV data are reassembled into a whole GOV by the help of the reference numbers in each RTP packet, that is, TxGOVSeqNum, Cr, and Tr (see FIG. 8). Because some RTP/UDP packets may be lost or arrive at the destination by out-of-sequence, the RTP/RTCP transport engine client 26 is designed to handle the proceeding problems. There are three types of RG (RTP GOV), that is, new RG, middle RG, and last RG (end RG), where new RG is the first segment of the GOV, last RG (end RG) is the last segment of the GOV, and the rest RGs are middle RGs.

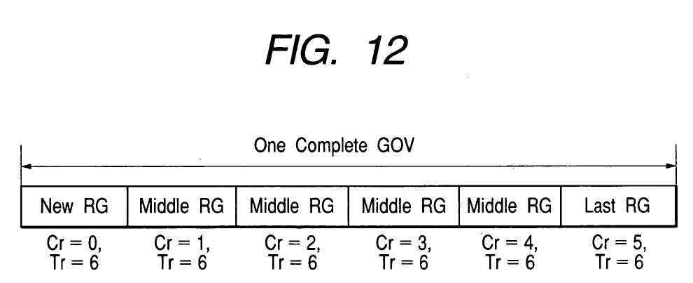

FIG. 12 shows the structure of a complete GOV with RG (RTP GOV). As shown in FIG. 12, head and end portions of the complete GOV are occupied by a new RG and a last RG (an end RG) respectively. The intermediate portion of the complete GOV is occupied by middle RGs sandwiched between the new RG and the last RG.

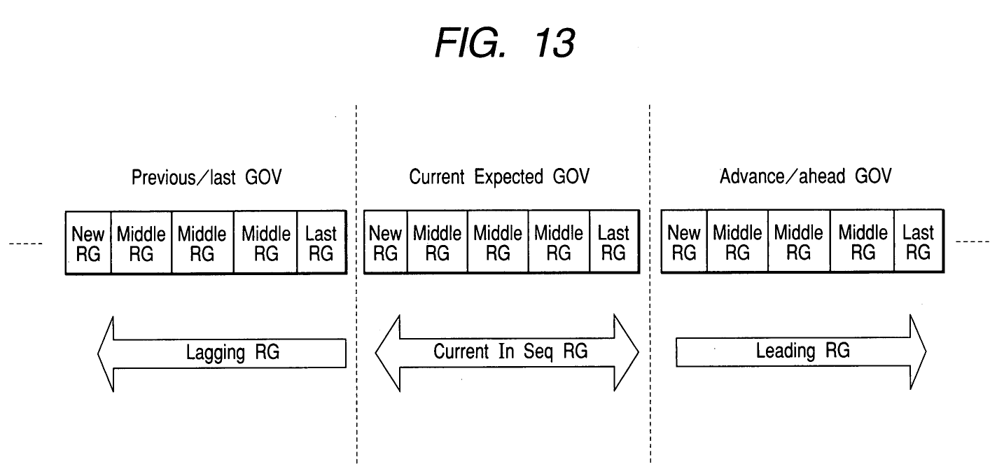

There are three cases for an RTP packet arriving at the client 12, that is, (1) the RTP packet belonging to the current expected GOV, (2) the RTP packet belonging to the GOV that should have been received before the current expected GOV, and (3) the RTP packet belonging to the GOV that should be received after the current expected GOV. Correspondingly, as shown in FIG. 13, there are three definitions, that is, current-in-sequence RG, lagging RG, and leading RG.

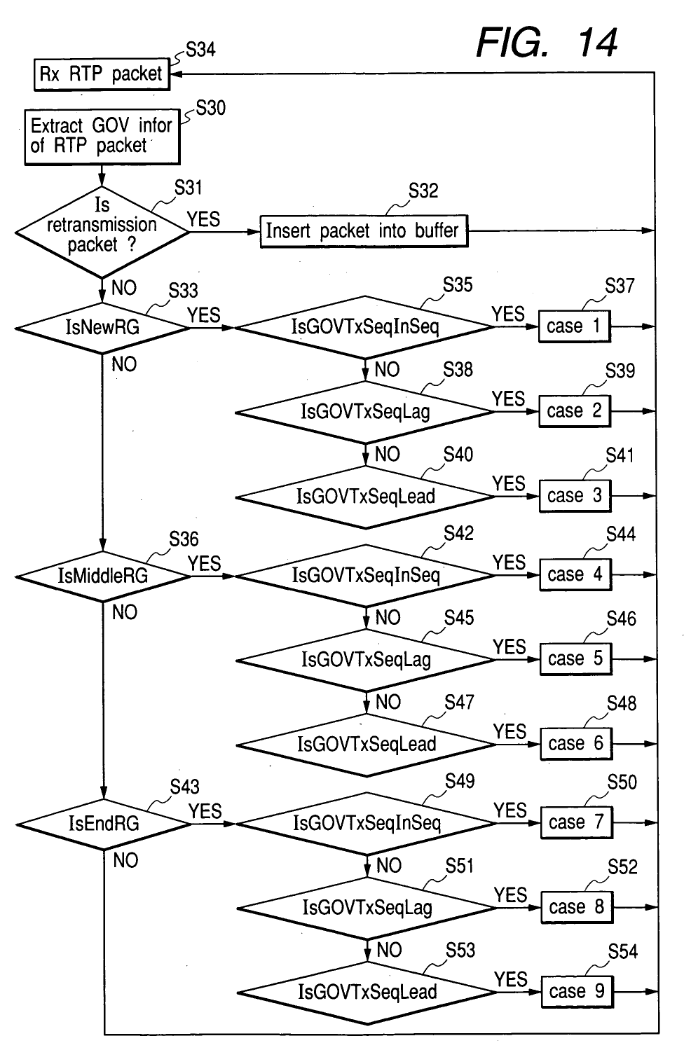

FIG. 14 is an operation flow diagram showing the processing operation of the RTP/RTCP transport engine client 26 which is implemented according to the corresponding segment of the control program for the computer in the client 12. The processing operation of the RTP/RTCP transport engine client 26 in FIG. 14 is executed upon the reception of every RTP packet.

With reference to FIG. 14, a first step S30 extracts the GOV information from the current RTP packet. A step S31 following the step S30 decides whether or not the current RTP packet is a retransmission packet by referring to the extracted GOV information. When the current RTP packet is a retransmission packet, the step S31 is followed by a step S32. Otherwise, the step S31 is followed by a step S33.

The step S32 extracts retransmitted data from the current RTP packet, and inserts the retransmitted data into the data link buffer 28. The step S32 is followed by a step S34 for receiving a next RTP packet.

The step S33 decides whether or not the current RTP packet is a new RG by referring to the GOV information. When the current RTP packet is a new RG, the step S33 is followed by a step S35. Otherwise, the step S33 is followed by a step S36.

The step S35 decides whether or not the current RTP packet belongs to the current expected GOV, that is, whether or not the current RG is a current-in-sequence RG, by referring to the GOV information. When the current RTP packet belongs to the current expected GOV, that is, when the current RG is a current-in-sequence RG, the step S35 is followed by a block S37 assigned to a case 1. Otherwise, the step S35 is followed by a step S38.

The step S38 decides whether or not the current RTP packet belongs to the GOV that should have been received before the current expected GOV, that is, whether or not the current RG is a lagging RG, by referring to the GOV information. When the current RTP packet belongs to the GOV that should have been received before the current expected GOV, that is, when the current RG is a lagging RG, the step S38 is followed by a block S39 assigned to a case 2. Otherwise, the step S38 is followed by a step S40.

The step S40 confirms whether the current RTP packet belongs to the GOV that should have been received after the current expected GOV, that is, whether the current RG is a leading RG, by referring to the GOV information. Then, the step S40 is followed by a block S41 assigned to a case 3.

The step S36 decides whether or not the current RTP packet is a middle RG by referring to the GOV information. When the current RTP packet is a middle RG, the step S36 is followed by a step S42. Otherwise, the step S36 is followed by a step S43.

The step S42 decides whether or not the current RTP packet belongs to the current expected GOV, that is, whether or not the current RG is a current-in-sequence RG, by referring to the GOV information. When the current RTP packet belongs to the current expected GOV, that is, when the current RG is a current-in-sequence RG, the step S42 is followed by a block S44 assigned to a case 4. Otherwise, the step S42 is followed by a step S45.

The step S45 decides whether or not the current RTP packet belongs to the GOV that should have been received before the current expected GOV, that is, whether or not the current RG is a lagging RG, by referring to the GOV information. When the current RTP packet belongs to the GOV that should have been received before the current expected GOV, that is, when the current RG is a lagging RG, the step S45 is followed by a block S46 assigned to a case 5. Otherwise, the step S45 is followed by a step S47.

The step S47 confirms whether the current RTP packet belongs to the GOV that should have been received after the current expected GOV, that is, whether the current RG is a leading RG, by referring to the GOV information. Then, the step S47 is followed by a block S48 assigned to a case 6.

The step S43 decides whether or not the current RTP packet is an end RG (a last RG) by referring to the GOV information. When the current RTP packet is an end RG, the step S43 is followed by a step S49. Otherwise, the step S43 is followed by the step S34.

The step S49 decides whether or not the current RTP packet belongs to the current expected GOV, that is, whether or not the current RG is a current-in-sequence RG, by referring to the GOV information. When the current RTP packet belongs to the current expected GOV, that is, when the current RG is a current-in-sequence RG, the step S49 is followed by a block S50 assigned to a case 7. Otherwise, the step S49 is followed by a step S51.

The step S51 decides whether or not the current RTP packet belongs to the GOV that should have been received before the current expected GOV, that is, whether or not the current RG is a lagging RG, by referring to the GOV information. When the current RTP packet belongs to the GOV that should have been received before the current expected GOV, that is, when the current RG is a lagging RG, the step S51 is followed by a block S52 assigned to a case 8. Otherwise, the step S51 is followed by a step S53.

The step S53 confirms whether the current RTP packet belongs to the GOV that should have been received after the current expected GOV, that is, whether the current RG is a leading RG, by referring to the GOV information. Then, the step S53 is followed by a block S54 assigned to a case 9.

The blocks S37, S39, S41, S44, S46, S48, S50, S52, and S54 are followed by the step S34.

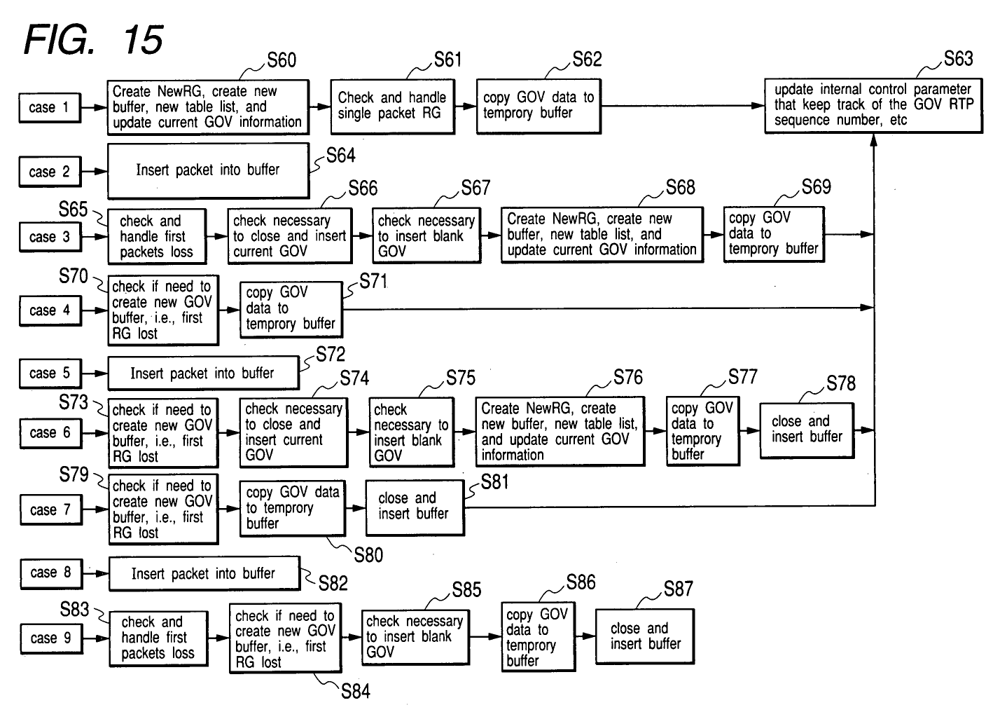

FIG. 15 shows the details of the blocks S37, S39, S41, S44, S46, S48, S50, S52, and S54 which are assigned to the cases 1, 2, 3, 4, 5, 6, 7, 8, and 9 respectively. As shown in FIG. 15, the block S37 assigned to the case 1 has step S60, S61, S62, and S63. The step S60 creates a new RG, a new buffer, and a new table list, and updates the current GOV information. The step S61 follows the step S60. The step S61 checks and handles the single packet RG. The step S62 is subsequent to the step S61. The step S62 copies GOV data in the current RG (the current RTP packet) to the temporary buffer. The step S63 follows the step S62. The step S63 updates an internal control parameter that keeps the track of the GOV RTP sequence number. The step S63 is followed by the step S34 (see FIG. 14).

The block S39 assigned to the case 2 has a step S64. The step S64 extracts GOV data from the current RTP packet, and inserts the extracted GOV data into the data link buffer 28. The step S64 is followed by the step S34 (see FIG. 14).

The block S41 assigned to the case 3 has step S65, S66, S67, S68, and S69. Furthermore, the block S41 has the step S63. The step S65 checks and handles the first packet's loss. The step S66 follows the step S65. The step S66 checks if it is necessary to close and insert a current GOV. The step S67 is subsequent to the step S66. The step S67 checks if it is necessary to insert a blank GOV. The step S68 follows the step S67. The step S68 creates a new RG, a new buffer, and a new table list, and updates the current GOV information. The step S69 is subsequent to the step S68. The step S69 copies GOV data in the current RG (the current RTP packet) to the temporary buffer. The step S69 is followed by the step S63.

The block S44 assigned to the case 4 has step S70 and S71. Furthermore, the block S44 has the step S63. The step S71 checks if it is necessary to create a new GOV temporary buffer, that is, if a first RG is lost. The step S71 follows the step S70. The step S71 copies GOV data in the current RG (the current RTP packet) to the temporary buffer. The step S71 is followed by the step S63.

The block S46 assigned to the case 5 has a step S72. The step S72 extracts GOV data from the current RTP packet, and inserts the extracted GOV data into the data link buffer 28. The step S72 is followed by the step S34 (see FIG. 14).

The block S48 assigned to the case 6 has step S73, S74, S75, S76, S77, and S78. Furthermore, the block S48 has the step S63. The step S73 checks if it is necessary to create a new GOV temporary buffer, that is, if a first RG is lost. The step S74 follows the step S73. The step S74 checks if it is necessary to close and insert a current GOV. The step S75 is subsequent to the step S74. The step S75 checks if it is necessary to insert a blank GOV. The step S76 follows the step S75. The step S76 creates a new RG, a new buffer, and a new table list, and updates the current GOV information. The step S77 is subsequent to the step S76. The step S77 copies GOV data in the current RG (the current RTP packet) to the temporary buffer. The step S78 follows the step S77. The step S78 closes the current GOV and inserts it into the data link buffer 28. The step S78 is followed by the step S63.

The block S50 assigned to the case 7 has step S79, S80, and S81. Furthermore, the block S50 has the step S63. The step S79 checks if it is necessary to create a new GOV temporary buffer, that is, if a first RG is lost. The step S80 follows the step S79. The step S80 copies GOV data in the current RG (the current RTP packet) to the temporary buffer. The step S81 is subsequent to the step S80. The step S81 closes the current GOV and inserts it into the data link buffer 28. The step S81 is followed by the step S63.

The block S52 assigned to the case 8 has a step S82. The step S82 extracts GOV data from the current RTP packet, and inserts the extracted GOV data into the data link buffer 28. The step S82 is followed by the step S34 (see FIG. 14).

The block S54 assigned to the case 9 has step S83, S84, S85, S86, and S87. The step S83 checks and handles the first packet's loss. The step S84 follows the step S83. The step S84 checks if it is necessary to create a new GOV temporary buffer, that is, if a first RG is lost. The step S85 is subsequent to the step S84. The step S85 checks if it is necessary to insert a blank GOV. The step S86 follows the step S85. The step S86 copies GOV data in the current RG (the current RTP packet) to the temporary buffer. The step S87 is subsequent to the step S86. The step S87 closes the current GOV and inserts it into the data link buffer 28. The step S87 is followed by the step S34 (see FIG. 14).

In a normal transmission, a new RG arrives at first, being followed by some middle RGs. Finally, a last RG arrives. All of the RGs fall in the current-in-sequence RG category, that is, the cases 1, 4, and 7. For instance, if the last RG being a current-in-sequence RG is lost, the RTP/RTCP transport engine client 26 will receive a new RG without closing the current GOV. Therefore, the RTP/RTCP transport engine client 26 closes the current GOV with an incomplete flag being set, and inserts the current GOV into the data link buffer 28 before going to handle the new RG packet. Furthermore, the RTP/RTCP transport engine client 26 is designed to also handle a special case that a GOV only has one RG packet.

The mechanism of the bitrate control is divided into two categories, that is, first one to deal with the scenario that the network bandwidth (BW) is decreasing and second one to poll the current network BW when the current streaming status is quite satisfactory so that the data bitrate could be possibly increased to match the network BW. The decision of the bitrate control is dependent on the status of the data link buffer 28 in the client 12 which reflects the statistical information of the packet loss rate, the packet transmission delay, the packet retransmission rate, and the successful packet retransmission rate.

The data link buffer 28 in the client 12 is responsible for storing GOV data, collecting the bitrate control information (the statistical information), and issuing retransmission requests. The basic attribute of the data link buffer 28 is a link of GOV nodes, which is defined as follows.

---------- ---------- ---------- ----------

/ / this definition is for the mapping of RTP packet Num and its receiving
status
/ / it is for the retransmission searching and lost packet writing
typedef struct RTPPktNumToRecvStatus{

| | | |
|---|---|---|
| DWORD | dwRTPPktNo; | / / RTP packet's number in |

this GOV (the nth RTP packet)

| | | |
|---|---|---|
| BOOL | bRTPPktRecvStatus; | / / corresponding receiving |

status

} RTP_PKT_NUM_TO_RECV_STATUS;
/ / the definition of Streaming Client Data Buffer Node structure
typedef struct StreamingClientDataBufferNode{

| LPBYTE | pGOVData; | / / the pointer that points to |
|---|---|---|
| | | the GOV data buffer |
| DWORD | dwGOVDataBuffSize; / / the byte's number of the | |
| | | GOV data buffer |
| DWORD | dwGOVDataSize; | / / the actual byte's number of |
| | | GOV data |
| DWORD | dwPreviousGOVBitrate; | / / the bitrate of last GOV |
| DWORD | dwCurrentGOVBitrate; | / / the bitrate of current GOV |
| DWORD | dwCurrentGOVPTS; | / / the starting PTS of current |
| | | GOV |
| DWORD | dwCurrentGOVDuration; | / / the duration of current |
| | | GOV |
| DWORD | dwCurrentGOVSeqNum; | / / the unique sequence |
| | | number of current GOV |
| DWORD | dwNumOfFrame; | / / the frame number of |
| | | current GOV |
| DWORD | dwCurrentGOVTransmissionSeqNum; | |
| | | / / the unique sequence |
| | | number of current GOV |
| | | / / but for transmission |
| | | purpose, this value is |
| | | obtained from Streaming |
| | | Server |
| DWORD | dwCurrGOVRTPTransSeqNum; | |
| | | / / this value is from the RTP |
| | | layer, it is for retransmission |
| | | to distinguish GOV |
| bool | bGOVCompleted; | / / if any RTP packet is lost for |
| | | this GOV, |
| | | / / this value should be false |
| bool | bBlankGOV; | / / if this is a blank GOV, then |
| | | is true |
| bool | bRetransmitPermission; | / / if the GOV is not completed |
| | | and cannot be retransmitted |
| | | / / this value should be false |
| int | nRTPPacketSize; | / / the size of RTP packet |
| int | nTotalRTPPacketNum; | / / how many RTP packets for |
| | | this GOV |

| | |
|---|---|
| RTP_PKT_NUM_TO_RECV_STATUS* | m_pRTPPktRecvStatusMap; |

/ / this points to an array whose size is the
nTotalRTPPacketNum
/ / this array is to indicate the status of the RTP packets
/ / true: the RTP packet with the corresponding number
has been received
/ / false: the RTP packet with the corresponding number
has been lost
/ / depending on the nTotalRTPPacketNum, this array
should be dynamically adjusted

} STREAMING_CLIENT_DATA_BUFFER_NODE;

---------- ---------- ---------- ----------

Moreover, there are four basic interfaces (1), (2), (3), and (4) in the data link buffer 28 within the client 12. The four basic interfaces (1), (2), (3), and (4) are as follows.

(1) ReadGOV( )

This is the interface that is exposed to the MPEG-4 decoder 13 for reading one GOV from the data link buffer 28 in the client 12.

(2) InsertGOV( )

This is the interface that is exposed to the RTP/RTCP transport engine client 26 for inserting one newly received GOV.

(3) InsertBlankGOV( )

This is the interface that is exposed to the RTP/RTCP transport engine client 26 for inserting a blank GOV that has no data into the data link buffer 28.

(4) InsertGOVRTPPacket( )

This is the interface that is exposed to the RTP/RTCP transport engine client 26 for inserting one RTP packet payload that belongs to a certain GOV into the data link buffer 28.

There are three basic types (1), (2), and (3) of GOV as follows.

(1) Complete GOV

This refers to a GOV whose RTP packets can be received by the RTP/RTCP transport engine client 26 in-sequence, fully, correctly and in time; therefore, it can be reconstructed by the RTP/RTCP transport engine client 26 successfully. A complete GOV is directly inserted into the data link buffer 28 within the client 12 as a complete GOV node through the interface “InsertGOV( )”. The sum of duration of all the complete GOVs in the data link buffer 28, which have not yet been read by the MPEG-4 decoder 13, is called the remaining GOV playback time.

(2) Incomplete GOV

This refers to a GOV whose RTP packets are received partially due to the packet loss or the long transmission delay. The RTP/RTCP transport engine client 26 can only reconstruct a GOV with some data being absent and insert the incomplete GOV into the data link buffer 28 through the interface “InsertGOV( )”. The system will try to recover the absent data of the incomplete GOV later by retransmitting those lost RTP packets if possible (as long as the original GOV is still in the data link buffer 24 within the streaming server 11). If retransmission is successful and the absent data is recovered through the interface “InsertGOVRTPPacket( )”, the incomplete GOV is corrected to a complete GOV and its duration will be added into the remaining GOV playback time in the next calculation.

(3) Blank GOV

This refers to a GOV whose RTP packets are not received but whose following GOV or GOVs are received by the RTP/RTCP transport engine client 26. In order to keep the sequence of the received GOVs, the RTP/RTCP transport engine client 26 will create a blank GOV and insert it into the data link buffer 28 through the interface “InsertBlankGOV( )”. A blank GOV resides at its should-be position in the data link buffer 28 and is replaced with or corrected into a recovered complete GOV by retransmitting the whole original GOV later (as long as the original GOV is still in the data link buffer 24 within the streaming server 11). If retransmission is successful and the absent data is recovered through the interface “InsertGOVRTPPacket( )”, the blank GOV is corrected into a complete GOV and its duration will be added into the remaining GOV playback time in the next calculation.

The collecting of bitrate control information is triggered when the MPEG-4 decoder 13 is taking a GOV out of the data link buffer 28 whereas the checking of retransmission tryouts is triggered when the RTP/RTCP transport engine client 26 is inserting a GOV into the data link buffer 28.

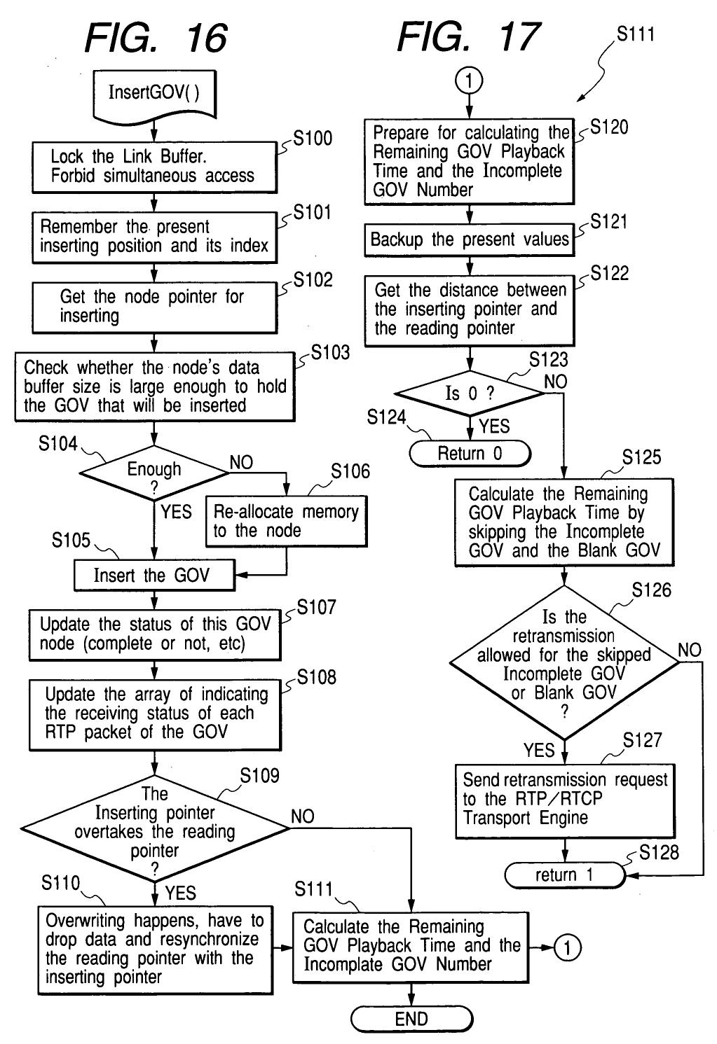

FIG. 16 is a flowchart showing the process of GOV insertion in the data link buffer 28 within the client 12 which is implemented according to the corresponding segment of the control program for the computer in the client 12.

With reference to FIG. 16, a first step S100 locks the data link buffer 28, and forbids simultaneous access thereto. A step S101 following the step S100 remembers the present inserting position and its index. A step S102 subsequent to the step S101 gets the node pointer for insertion.

A step S103 following the step S102 checks whether the node's data buffer size is large enough to hold the GOV data that will be inserted. A step S104 subsequent to the step S103 decides the result of the check by the step S103. When the check result indicates that the node's data buffer size is large enough to hold the GOV data, the step S104 is followed by a step S105. Otherwise, the step S104 is followed by a step S106.

The step S106 reallocates a suitable memory area (suitable buffer area) to the node. The step S106 is followed by the step S105. The step S105 inserts the GOV into the data link buffer 28.

A step S107 subsequent to the step S105 updates the status of this GOV node which represents, for example, whether or not the GOV is complete. A step S108 following the step S107 updates the array of indication of the receiving status of RTP packets of the GOV.

A step S109 subsequent to the step S108 decides whether or not the inserting pointer overtakes the reading pointer. When the inserting pointer overtakes the reading pointer, the step S109 is followed by a step S110. Otherwise, the step S109 is followed by a block S111.

The step S110 recognizes that overwriting happens. The step S110 drops improper data, and synchronizes the reading pointer with the inserting pointer. The step S110 is followed by the block S111.

The block S111 calculates the remaining GOV playback time and the incomplete GOV number. The block S111 is realized by a related function call with a return value of either “0” or “1”. After the block S111, the process of GOV insertion ends.

As shown in FIG. 17, the block S111 includes steps S120-S128. The step S120 follows the step S109 or the step S10. The step S120 prepares for calculating the remaining GOV playback time and the incomplete GOV number. The step S121 is subsequent to the step S120. The step S121 backs up the present values. The step S122 follows the step S121. The step S122 gets the distance between the inserting pointer and the reading pointer. The step S123 is subsequent to the step S122. The step S123 decides whether or not the calculated distance is 0. When the calculated distance is 0, the step S123 is followed by the step S124. Otherwise, the step S123 is followed by the step S125. At the step S124, the return from the related function call is implemented, and the process in the block S111 ends. The step S125 calculates the remaining GOV playback time by skipping the incomplete GOV and the blank GOV. The step S126 follows the step S125. The step S126 decides whether or not the retransmission is allowed for the skipped incomplete GOV or blank GOV. When the retransmission is allowed, the step S126 is followed by the step S127. Otherwise, the step S126 is followed by the step S128. The step S127 sends a retransmission request to the RTP/RTCP transport engine server 22. The step S127 is followed by the step S128. At the step S128, the return from the related function call is implemented, and the process in the block S111 ends.

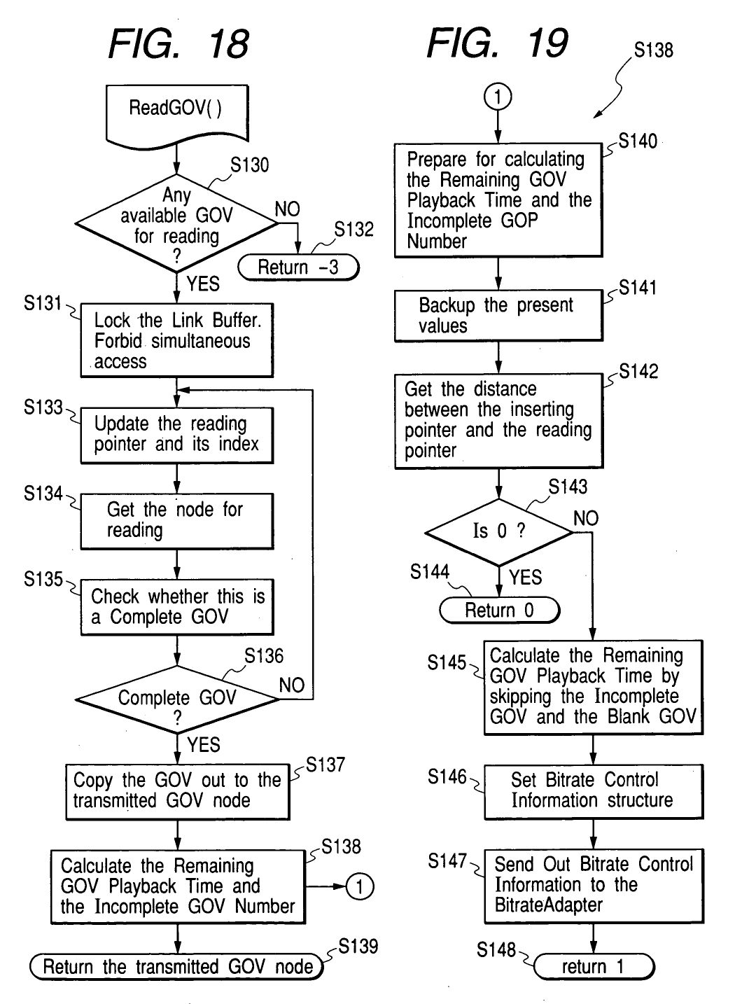

FIG. 18 is a flowchart showing the process of GOV reading in the data link buffer 28 within the client 12 which is implemented according to the corresponding segment of the control program for the computer in the client 12.

With reference to FIG. 18, a first step S130 checks whether or not at least one available GOV is in the data link buffer 28. When at least one available GOV is in the data link buffer 28, the step S130 is followed by a step S131. Otherwise, the step S130 is followed by a step S132.

At the step S132, the return to the parent process with respect to the process of GOV reading is implemented, and hence the process of GOV reading ends.

The step S131 locks the data link buffer 28, and forbids simultaneous access thereto. The step S131 is followed by a step S133. The step S133 updates the reading pointer and its index. A step S134 subsequent to the step S133 gets the node for reading.

A step S135 following the step S134 checks whether the present GOV is complete one. A step S136 subsequent to the step S135 decides the result of the check by the step S135. When the check result indicates that the present GOV is complete one, the step S136 is followed by a step S137. Otherwise, the step S136 is followed by the step S133.

The step S137 copies the GOV out to the transmitted GOV node. The step S137 is followed by a block S138.

The block S138 calculates the remaining GOV playback time and the incomplete GOV number. The block S138 is realized by a related function call with a return value of either “0” or “1”. The block S138 is followed by a step S139.

At the step S139, the return to the parent process with respect to the process of GOV reading is implemented, and hence the process of GOV reading ends.

As shown in FIG. 19, the block S138 includes steps S140-S148. The step S140 follows the step S137. The step S140 prepares for calculating the remaining GOV playback time and the incomplete GOV number. The step S141 is subsequent to the step S140. The step S141 backs up the present values. The step S142 follows the step S141. The step S142 gets the distance between the inserting pointer and the reading pointer. The step S143 is subsequent to the step S142. The step S143 decides whether or not the calculated distance is 0. When the calculated distance is 0, the step S143 is followed by the step S144. Otherwise, the step S143 is followed by the step S145. At the step S144, the return from the related function call is implemented, and the process in the block S138 ends. The step S145 calculates the remaining GOV playback time by skipping the incomplete GOV and the blank GOV. The step S146 follows the step S145. The step S146 sets a bitrate control information structure. The step S147 is subsequent to the step S146. The step S147 sends out bitrate control information to the bit rate adapter module 27. The step S147 is followed by the step S148. At the step S148, the return from the related function call is implemented, and the process in the block S138 ends.

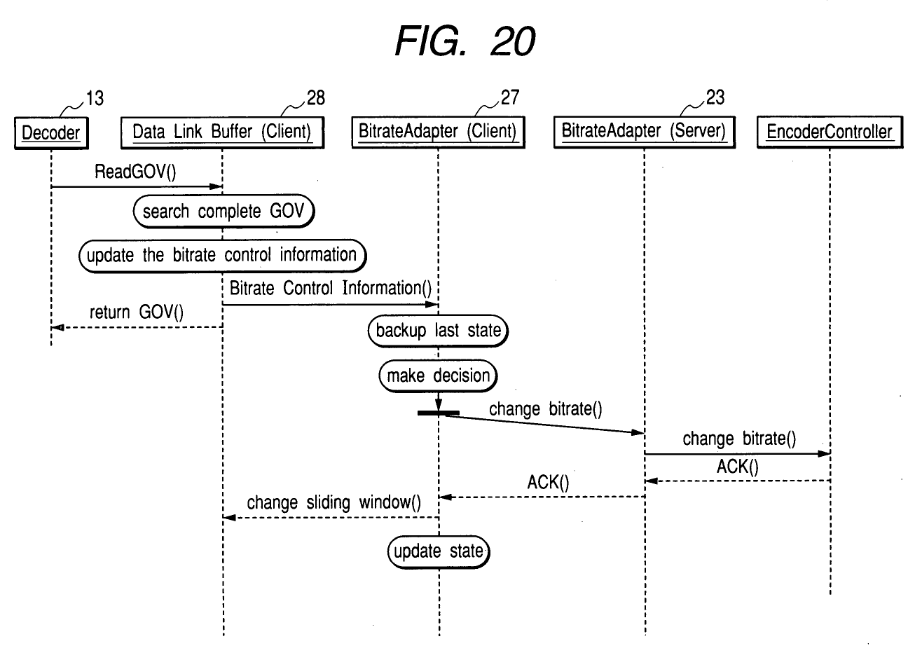

FIG. 20 is a time sequence diagram showing the bitrate control message flows. With reference to FIG. 20, the MPEG-4 decoder 13 feeds the data link buffer 28 with a request for reading a GOV. In response to the request, the data link buffer 28 searches for the requested complete GOV. The data link buffer 28 updates the bitrate control information. The data link buffer 28 sends the bitrate control information to the bitrate adapter module 27 in the client 12. The data link buffer 28 returns the requested complete GOV to the MPEG-4 decoder 13. The bitrate adapter module 27 backs up the last state. The bitrate adapter module 27 makes a decision about bitrate change, and generates a corresponding bitrate change command (bitrate control command). The bitrate adapter module 27 sends the bitrate change command to the bitrate adapter module 23 in the streaming server 11. The bitrate adapter module 23 passes the bitrate change command to the controller in the MPEG-4 encoder 10. Upon the reception of the bitrate change command, the controller in the MPEG-4 encoder 10 returns an acknowledgement to the bitrate adapter module 23 in the streaming server 11. The bitrate adapter module 23 passes the acknowledgement to the bitrate adapter module 27 in the client 12. The bitrate adapter module 27 feeds the data link buffer 28 with a command to change a sliding window. The bitrate adapter module 27 updates the state.

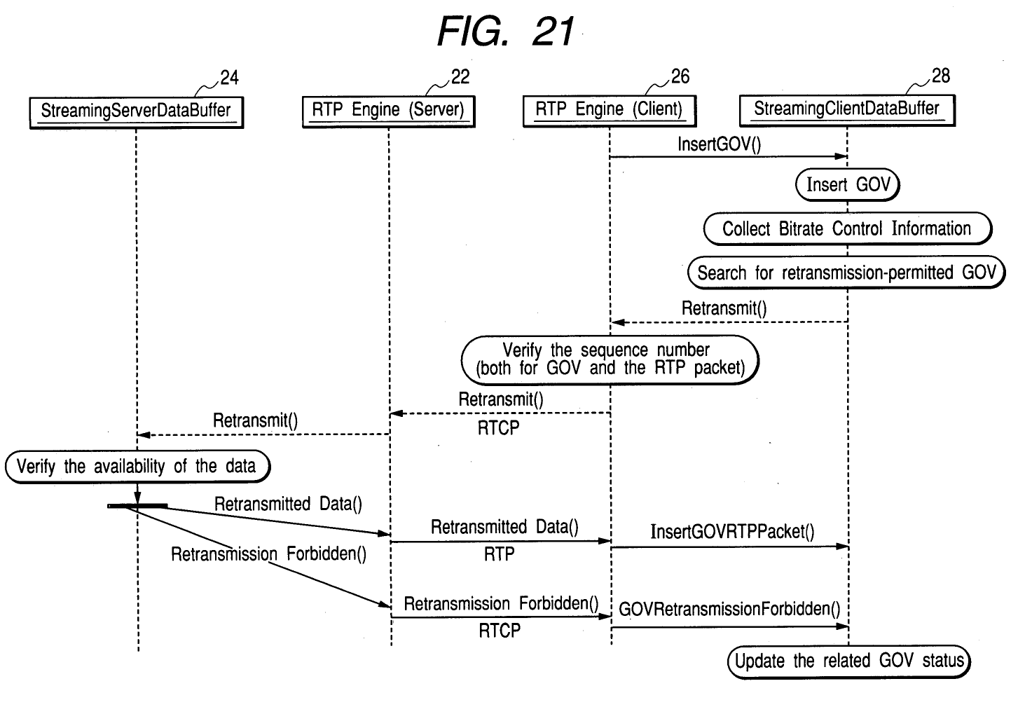

FIG. 21 is a time sequence diagram showing the retransmission message flows. With reference to FIG. 21, the RTP/RTCP transport engine client 26 inserts a GOV into the data link buffer 28 in the client 12. The data link buffer 28 collects the bitrate control information. The data link buffer 28 searches for a retransmission-permitted GOV (for example, an incomplete GOV or a blank GOV) therein. When the retransmission-permitted GOV is found, the data link buffer 28 sends a corresponding retransmission request to the RTP/RTCP transport engine client 26. The RTP/RTCP transport engine client 26 analyzes the retransmission request and thereby verifies the sequence numbers for both the GOV and the related RTP packet (or packets). The RTP/RTCP transport engine client 26 passes the retransmission request to the RTP/RTCP transport engine server 22. The RTP/RTCP transport engine server 22 passes the retransmission request to the data link buffer 24 in the streaming server 11. The data link buffer 24 verifies the availability of the requested data (the data to be retransmitted). The data link buffer 24 sends either the retransmitted data or a retransmission-forbidden notice to the RTP/RTCP transport engine server 22. The RTP/RTCP transport engine server 22 passes the retransmitted data or the retransmission-forbidden notice to the RTP/RTCP transport engine client 26 by use of an RTP packet. The RTP/RTCP transport engine client 26 extracts the GOV fragment data from the RTP packet, and inserts the GOV fragment data into the data link buffer 28 in the client 12. Alternatively, the RTP/RTCP transport engine client 26 passes the retransmission-forbidden notice to the data link buffer 28. The data link buffer 28 updates the related GOV status.

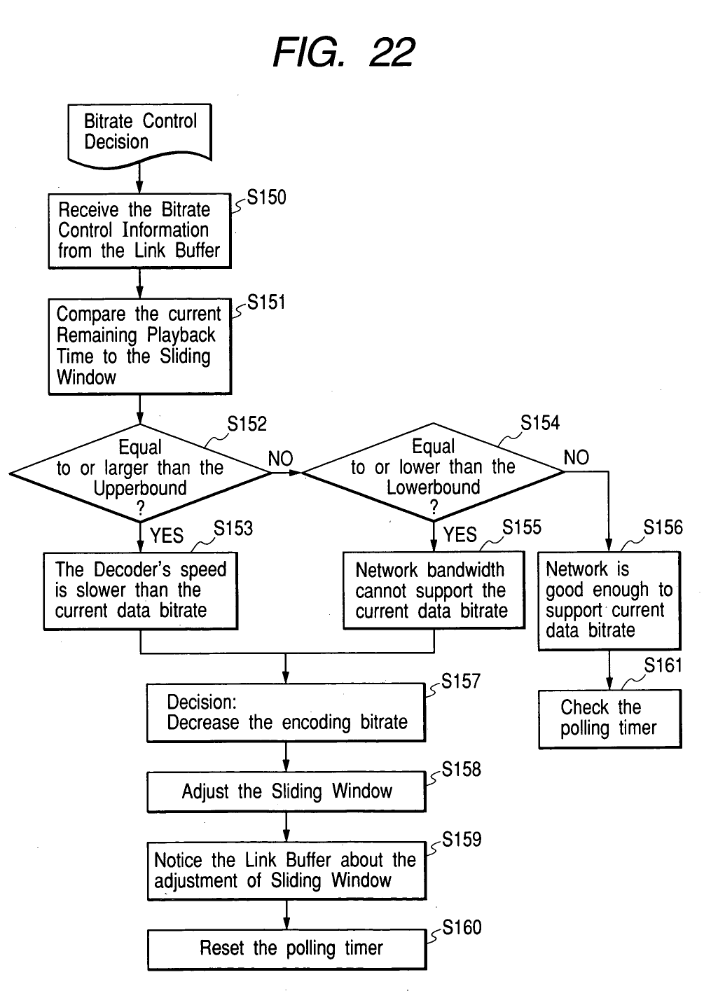

FIG. 22 is a flowchart showing the process of making a bitrate control decision in the client 12 which is implemented according to the corresponding segment of the control program for the computer in the client 12.

With reference to FIG. 22, a first step S150 receives the bitrate control information from the data link buffer 28. A step S151 following the step S150 compares the current remaining playback time to the sliding window in consideration of upper and lower bounds.

A step S152 subsequent to the step S151 refers to the result of the comparison by the step S151, and thereby decides whether the current remaining playback time is equal to or larger than the upper bound with respect to the sliding window. When the current remaining playback time is equal to or larger than the upper bound, the step S152 is followed by a step S153. Otherwise, the step S152 is followed by a step S154.

The step S154 refers to the result of the comparison by the step S151, and thereby decides whether the current remaining playback time is equal to or lower than the lower bound with respect to the sliding window. When the current remaining playback time is equal to or lower than the lower bound, the step S154 is followed by a step S155. Otherwise, the step S154 is followed by a step S156.

The step S153 recognizes that the decoding speed of the MPEG-4 decoder 13 is slower than the current data bitrate. The step S155 recognizes that the network bandwidth can not support the current data bitrate.

A step S157 following the steps S153 and S155 decides that the encoding bitrate should be decreased. A step S158 subsequent to the step S157 adjusts the sliding window. A step S159 following the step S158 notices the data link buffer 28 about the adjustment of the sliding window. A step S160 subsequent to the step S159 resets the polling timer. After the step S160, the process of making a bitrate control decision ends.

The step S156 recognizes that the wireless network 15 is good enough to support the current data bitrate. A step S161 following the step S156 checks the polling timer. After the step S161, the process of making a bitrate control decision ends.

Regarding the process of making a bitrate control decision in FIG. 22, the key factor is the total remaining GOV playback time which is calculated in the data link buffer 28 within the client 12. The total remaining GOV playback time means how long will the MPEG-4 decoder 13 play back only based on the current buffered GOVs without considering any new incoming data. Among a complete GOV, an incomplete GOV, and a blank GOV, only the complete GOV (that is, the correctly recovered GOV) is considered as an effective GOV when the total remaining GOV playback time is calculated. The data buffer monitoring scheme, which ultimately realizes the variable bitrate control, is a sliding window monitoring system designed as follows. At first, an upper bound buffer level, a middle value buffer level, and a lower bound buffer level are defined which are measured by the playback time in the data link buffer 28. Those buffer levels construct the decision sliding window, in which the initial playback time/current playback time is set equal to the middle value. When the total remaining GOV playback time falls in the range between the upper bound and the lower bound, the network bandwidth is considered to be acceptable, that is, good enough to support the current streaming bitrate. It is unnecessary to adjust the encoding bitrate for such a case. Thus, in this case, the bitrate control information transmitted to the MPEG-4 encoder 10 is designed to hold the encoding bitrate unchanged. When the total remaining GOV playback time is in the region between the upper bound and the middle value, this condition means that sometimes in the data link buffer 28, the GOV leaving rate (caused by the MPEG-4 encoder 13 taking the data) is slower than the GOV arriving rate (caused by the wireless network 15 transmitting the data), in other words, the decoding rate of the MPEG-4 decoder 13 is slower than the data streaming bitrate. When the total remaining GOV playback time is equal to or over the upper bound, this condition means that the decoding rate of the MPEG-4 decoder 13 is too slow. To prevent the MPEG-4 decoder 13 from overloading in such a case, the bitrate control information (bitrate change command) transmitted to the MPEG-4 encoder 10 is designed to decrease the encoding bitrate to a reasonable stage to match the throughput of the MPEG-4 decoder 13 regardless of the health state of the bandwidth of the wireless network 15. On the other hand, when the total remaining GOV playback time is in the region between the middle value and the lower bound, this condition means that sometimes in the data link buffer 28, the GOV leaving rate (caused by the MPEG-4 encoder 13 taking the data) is faster than the GOV arriving rate (caused by the wireless network 15 transmitting the data), in other words, a packet loss happens or the transmission delay is slightly long. Thus, in such a case, retransmission tends to be necessary. When the total remaining GOV playback time is equal to or below the lower bound, this condition means that the wireless network 15 can not sustain the current data bitrate any more because of either a frequent packet loss or a long transmission delay. To prevent the MPEG-4 decoder 13 from being hungry for data in such a case, the bitrate control information (bit rate change command) transmitted to the MPEG-4 encoder 10 is designed to decrease the encoding bitrate to a reasonable stage to match the throughput of the wireless network 15.

As the MPEG-4 decoder 13 can be easily upgraded to a high performance machine to solve its throughput bottleneck, the bitrate control mechanism mainly focuses on the network deterioration case which is physically out of control by the system. If a packet loss happens or the packet transmission delay is longer than the 1-GOV playback time, or if there is any reason that will result in the absence of the expected GOV, the current buffer level (the total remaining GOV playback time) will drop. For instance, when the playback starts, the buffer level is set at the middle value. If a packet loss happens, the buffer level will drop to lower than the middle value after the MPEG-4 decoder 13 takes one GOV from the data link buffer 28 as the expected GOV can not arrive on time. If the lost packet can be retransmitted in time, the buffer level will go back to the middle value. But if the lost packet can not be retransmitted and more packet losses occur, the buffer level will continuously drop because there is no new GOV coming in time to fill up the buffer vacancies after the MPEG-4 decoder 13 takes out GOVs. When the buffer level reaches the lower bound, it is concluded that the current (past) bandwidth of the wireless network 15 can not support the current data bitrate. This decision result is fed back to the MPEG-4 encoder 10 as the bitrate control information, and the decision window is moved downwards by setting the current lower bound as the next-to-be middle value and setting the next-to-be upper bound and lower bound with predefined steps (distances) compared to the next-to-be middle value. If the situation becomes worse, the same downward adjustment of the decision window will continue. In general, under live streaming conditions, the data link buffer 28 can not be re-filled without pausing or stopping the decoding process. Thus, when the 0 lower bound is reached, that is, when there is no complete GOV in the data link buffer 28 any more, it is preferable to pause or stop the decoding process to re-fill the data link buffer 28. For such a case, the buffer decision levels will be set to the initial values, whereby the data link buffer 28 will be re-filled to the initial middle value and then the playback can be resumed.

The main process of the bitrate control has a sequence of steps or stages (1)-(8) as follows.

(1) The current remaining GOV playback time is collected which relates to the complete GOVs in the data link buffer 28 within the client 12.

(2) The current remaining GOV playback time is compared to the current decision sliding window.

(3) A decision is made as to the bitrate control in response to the result of the above-mentioned comparison.

(4) If the result of the above-mentioned decision indicates that the encoding bitrate needs to be changed, the corresponding message is sent to the MPEG-4 encoder 10 as the bitrate change command and the decision sliding window is adjusted. In addition, the polling timer is reset. If the result of the decision does not indicate that the encoding bitrate needs to be changed, the current state is remembered and a check is made as to whether the polling timer is triggered.

(5) If the polling timer is triggered, polling is started.

(6) Polling is stopped, and the polling timer is reset.

(7) If polling succeeds, the encoding bitrate is changed.

(8) The repeat is done from the step (1).

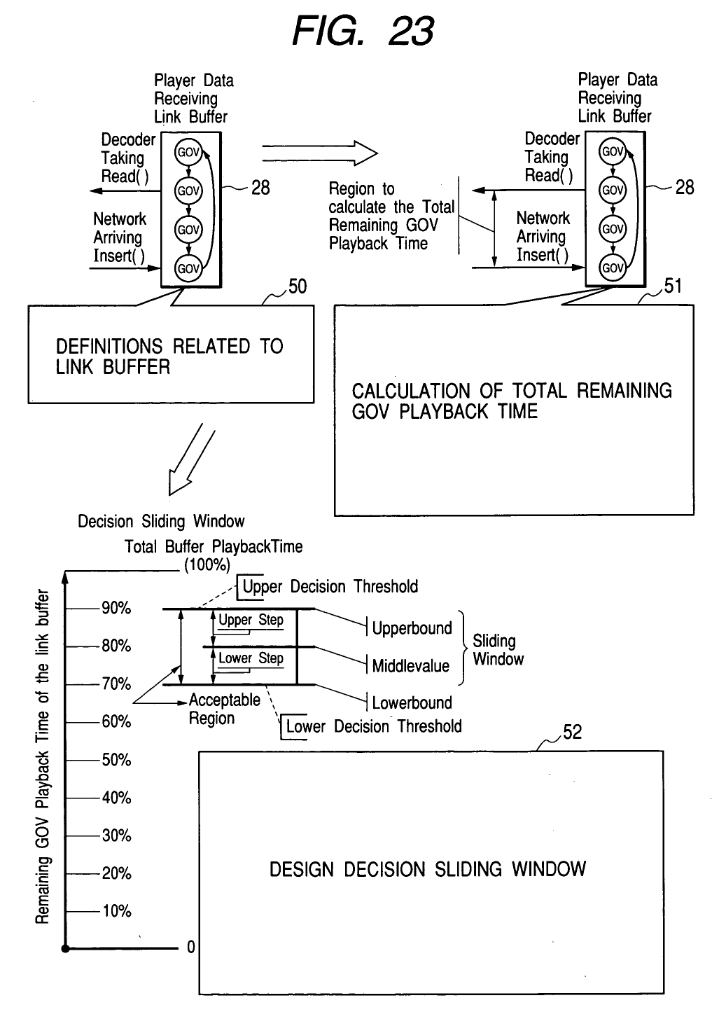

FIG. 23 shows the basic definitions of the bitrate control mechanism. With reference to FIG. 23, a GOV is read out from the data link buffer 28 by the MPEG-4 decoder 13 while a GOV transmitted through the wireless network 15 is inserted into the data link buffer 28. At a block 50 in FIG. 23, there are definitions related to the data link buffer 28. The definitions are as follows.

Storage Unit: GOV

Total Number of GOVs: N, e. g., 40

One-GOV Playback Time: M milliseconds, e. g., 1000 ms (1 second)

Total Buffer Playback Time: N×M ms, e. g., 40×1=40 seconds

As shown in FIG. 23, the region to calculate the total remaining GOV playback time corresponds to the distance between the GOV reading position in the data link buffer 28 and the GOV inserting position therein. A block 51 in FIG. 23 implements calculation of the total remaining GOV playback time. The details of the calculation are as follows.

1. The reading position is always behind the inserting position. If they are at the same position, it means that there is no GOV available in the data link buffer 28 either at the initial status or that when all the GOVs have been exhausted.

2. Only those GOVs that fall in between the inserting position and the reading position will be considered in the calculation.

3. Only every complete GOV (i. e., every correctly recovered GOV) will be considered in the calculation.

4. Every incomplete GOV and every blank GOV are out of the consideration even if they are in the calculation region.

5. If an incomplete GOV/blank GOV becomes a complete GOV as a result of retransmission and it is still in the calculation region when a new calculation is triggered, it then will be included in the new calculation.

6. The total remaining GOV playback time is equal to the number of the complete GOVs in the calculation region which is multiplied by the one-GOV playback time. For example, in the case where the number of the complete GOVs in the calculation region is 15 and the one-GOV playback time is 1 s (1 second), the total remaining GOV playback time is 15 s (15 seconds).

As shown in FIG. 23, the sliding window (decision sliding window) corresponds to an acceptable region. The sliding window has an upper bound and a lower bound. There is a middle value between the upper bound and the lower bound. Preferably, the middle value is equidistant from the upper bound and the lower bound. An upper step means the distance between the middle value and the upper bound. A lower step means the distance between the middle value and the lower bound. A block 52 in FIG. 23 designs the decision sliding window. The details of the designing are as follows.

1. The sliding window can only move in the range of 0 to the total buffer playback time.

2. The values of the upper bound, the middle value, and the lower bound can be arbitrary, but conform to the definitions of them.

3. The upper step and the lower step can be arbitrary, but preferably depend on the requirement of sensitivity and efficiency.

4. The decision is made when the current remaining GOV playback time reaches the upper decision threshold (upper bound) or the lower decision threshold (lower bound).

5. In order to simplify the problem, the region of [0, total buffer playback time] is divided into multiple small regions by means of percentage.

6. For instance, as the initial state, the settings are:

Upper Step=Lower Step=10%×Total Buffer Playback Time

Upper bound=90%×Total Buffer Playback Time

Middle value=80%×Total Buffer Playback Time

Lower bound=70%×Total Buffer Playback Time

e. g., if:

Total Number of GOVs: 40

One-GOV playback time: 1000 ms (1 second)

Total Buffer Playback Time: 40×1=40 seconds

then:

Upper Step=Lower Step=4 s

Upper bound=36 s

Middle value=32 s

Lower bound=28 s

it means:

1. only after the data link buffer 28 has been filled with the current remaining GOV playback time reaching the middle value (i. e., 32 s), the playback starts (the MPEG-4 decoder 13 starts taking data from the data link buffer 28);

2. if the current remaining GOV playback time reaches the lower decision threshold (lower bound, i. e., 28 s) during the playback, the playback bitrate control decision is made. So as to the upper bound.

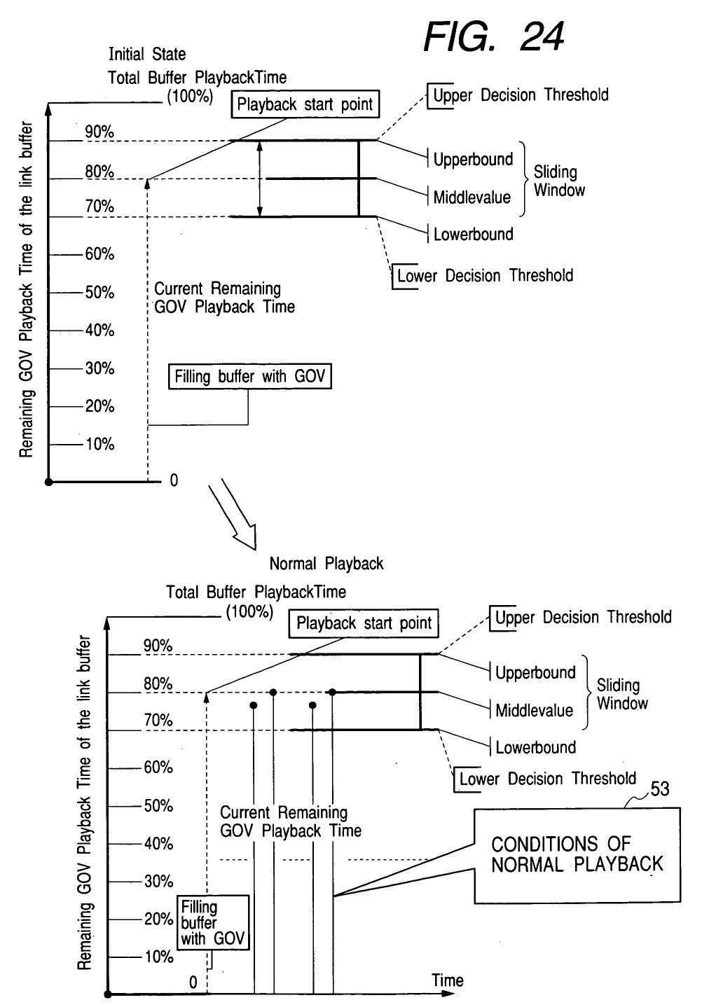

FIG. 24 shows the normal playback scenario of the bitrate control mechanism. As shown in FIG. 24, the playback start point corresponds to the current remaining GOV playback time reaching the middle value. A block 53 in FIG. 24 relates to conditions of normal playback. The details of the conditions are as follows. For normal playback, the current remaining GOV playback time will fall in the region between the upper bound and the lower bound. If the MPEG-4 decoder 13 is sufficiently good, the current remaining GOV playback time will fall in the region between the middle value and the lower bound.

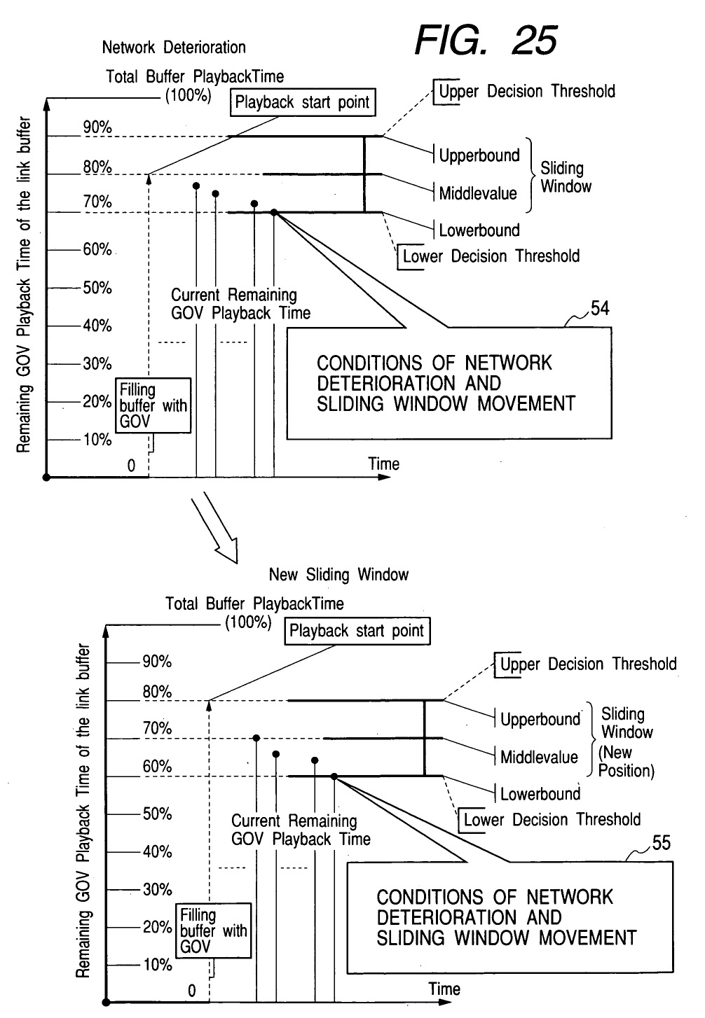

FIG. 25 shows the network deterioration scenario of the bitrate control mechanism. A block 54 in FIG. 25 relates to conditions of network deterioration and sliding-window movement which contain poor network conditions corresponding to the current remaining GOV playback time going down and reaching the lower bound. The details of the conditions of the network deterioration and the sliding-window movement are as follows. When the network bandwidth can not sustain the data bitrate, the current remaining GOV playback time will decrease continuously. If the current remaining GOV playback time reaches the lower decision threshold (lower bound), it is decided that the current encoding bitrate should decrease to a lower stage. After that, the sliding window is moved down to another position accordingly. The movement of the sliding widow is such that the current lower bound will be the next position's middle value. Then, the upper bound and the lower bound are adjusted for the next position according to the upper step and the lower step.

As shown in FIG. 25, the sliding window is shifted down to a new position so that a new sliding window occurs. A block 55 in FIG. 25 relates to conditions of network deterioration and sliding-window movement which contain poor network conditions corresponding to the current remaining GOV playback time going down and reaching the lower bound of the new sliding window. The details of the conditions of the network deterioration and the sliding-window movement are as follows. After the sliding window is adjusted to create new one and the encoding bitrate is decreased, if the network bandwidth still can not sustain the data bitrate, the current remaining GOV playback time will continue to drop. If the current remaining GOV playback time reaches the lower decision threshold (lower bound) again, it is decided that the current encoding bitrate should decrease to another much lower stage and the sliding-window adjustment should repeat. If the 0 lower bound has been reached, the decoding process is stopped or paused and the sliding window is reset to its initial state to refill the data link buffer 28.

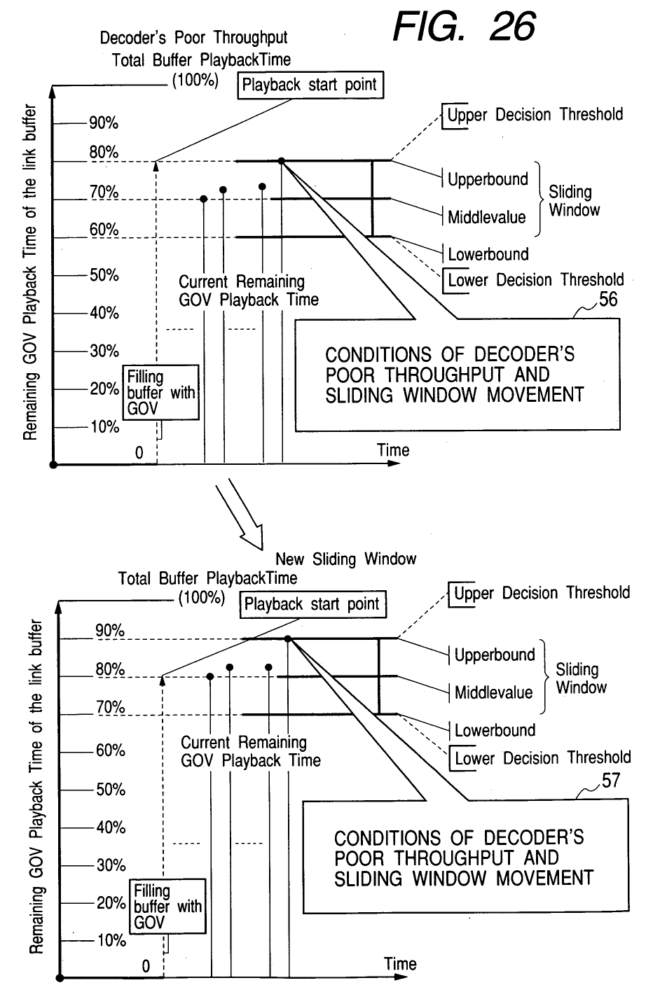

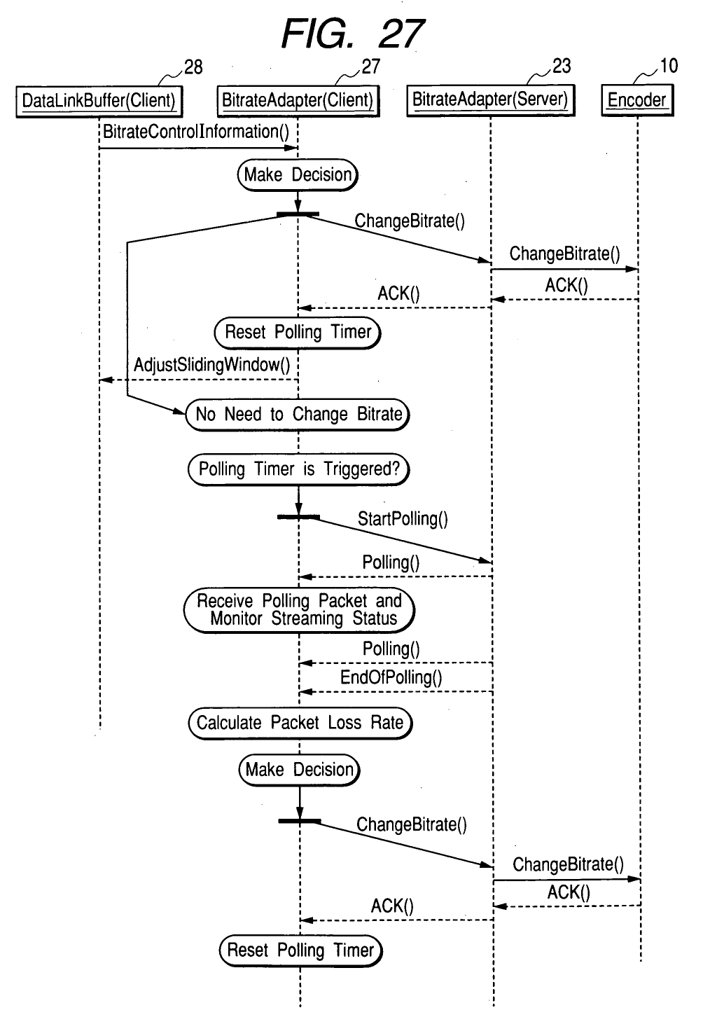

FIG. 26 shows the decoder's poor throughput scenario of the bitrate control mechanism. A block 56 in FIG. 26 relates to conditions of decoder's poor throughput and sliding-window movement which contain poor decoding conditions corresponding to the current remaining GOV playback time going up and reaching the upper bound. The details of the conditions of the decoder's poor throughput and the sliding-window movement are as follows. If the decoding speed of the MPEG-4 decoder 13 is slower than the data bitrate, the current remaining GOV playback time will increase bit by bit. If the current remaining GOV playback time reaches the upper decision threshold (upper bound), it is decided that the current encoding bitrate should decrease to a lower stage to match the throughput of the MPEG-4 decoder 13. After that, the sliding window is moved up to another position accordingly. The movement of the sliding widow is such that the current upper bound will be the next position's middle value. Then, the upper bound and the lower bound are adjusted for the next position according to the upper step and the lower step.

As shown in FIG. 26, the sliding window is shifted up to a new position so that a new sliding window occurs. A block 57 in FIG. 26 relates to conditions of decoder's poor throughput and sliding-window movement which contain poor decoding conditions corresponding to the current remaining GOV playback time going up and reaching the upper bound of the new sliding window. The details of the conditions of the decoder's poor throughput and the sliding-window movement are as follows. After the sliding window is adjusted to create new one and the encoding bitrate is decreased, if the decoder's throughput still can not support the data bitrate, the current remaining GOV playback time will continue to increase. If the current remaining GOV playback time reaches the upper decision threshold (upper bound) again, it is decided that the current encoding bitrate should decrease to another much lower stage and the sliding-window adjustment should repeat. If the 1 upper bound has been reached, the data bitrate is decreased again and some GOVs are dropped.

The polling process is designed to verify the availability of the next data bitrate stage. If the performance of the current network streaming is quite satisfactory and it has been lasted for a certain period, the network bandwidth is much probably higher than the current data bitrate. The network bandwidth polling is triggered by the polling timer. Since the normal streaming is kept on during the polling procedure, the polling and the current streaming will share the same bandwidth. Therefore, the polling bitrate is set as the difference between the next data bitrate and the current data bitrate. The polling is handled by the bitrate adapter module 23 in the streaming server 11 and the bitrate adapter module 27 in the client 12, whereas the bitrate adapter module 23 pushes RTP packets (UDP packets) to the bitrate adapter module 27 according to the polling bitrate. If the polling affects the current streaming performance or the packet loss rate of the polling exceeds a threshold, the network bandwidth can not support the next data bitrate stage. Otherwise, the encoding bitrate can be increased to the next higher stage. Moreover, if the condition of the polling is met again, the polling process will be conducted repeatedly until the maximum encoding bitrate is reached.

The principle of the polling is that if the remaining GOV playback time has been in a certain sliding window for a period long enough (e. g., 30 seconds), the polling should be processed to check whether the wireless network 15 can support a higher bitrate. If the sliding window is adjusted before the polling timer is triggered, the polling timer should be reset immediately.

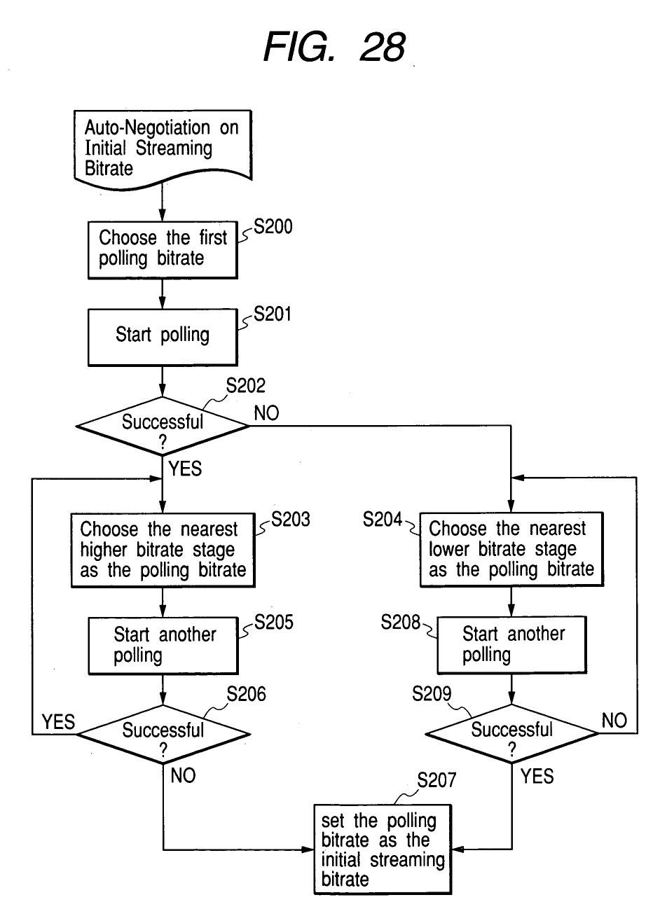

FIG. 27 is a time sequence diagram showing the polling process. With reference to FIG. 27, the bitrate control information is sent from the data link buffer 28 in the client 12 to the bitrate adapter module 27 therein. The bitrate adapter module 27 makes a decision about bitrate control in response to the bitrate control information. When the result of the decision indicates that the bitrate should be changed, the bitrate adapter module 27 generates a corresponding bitrate change request (bitrate change command). The bitrate change request is sent from the bitrate adapter module 27 to the bitrate adapter module 23 in the streaming server 11. The bitrate adapter module 23 passes the bitrate change request to the MPEG-4 encoder 10. Upon the reception of the bitrate change request, the MPEG-4 encoder 10 returns an acknowledgment to the bitrate adapter module 23. The bitrate adapter module 23 passes the acknowledgment to the bitrate adapter module 27 in the client 12. Then, the bitrate adapter module 27 resets the polling timer. The bitrate adapter module 27 adjusts the sliding window with respect to the data link buffer 28.

In the case where the result of the bitrate control decision indicates that the bitrate should not be changed or in the case where the sliding window has been adjusted, the bitrate adapter module 27 decides whether the polling timer is triggered. When the polling timer is triggered, the bitrate adapter module 27 starts the polling with the bitrate adapter module 23 in the streaming server 11. During the polling, the bitrate adapter module 27 receives polling packets from the bitrate adapter module 23 and monitors the streaming status. After the polling ends, the bitrate adapter module 27 calculates the packet loss rate from the information and conditions available during the polling. The bitrate adapter module 27 makes a decision about bitrate control in response to the calculated packet loss rate. When the result of the decision indicates that the bitrate should be changed, the bitrate adapter module 27 generates a corresponding bitrate change request (bitrate change command). The bitrate change request is sent from the bitrate adapter module 27 to the bitrate adapter module 23 in the streaming server 11. The bitrate adapter module 23 passes the bitrate change request to the MPEG-4 encoder 10. Upon the reception of the bitrate change request, the MPEG-4 encoder 10 returns an acknowledgment to the bitrate adapter module 23. The bitrate adapter module 23 passes the acknowledgment to the bitrate adapter module 27 in the client 12. Then, the bitrate adapter module 27 resets the polling timer.

There is another kind of polling for auto-setting the initial streaming bitrate. This is also done by the negotiation between the bitrate adapter module 23 in the streaming server 11 and the bitrate adapter module 27 in the client 12. The polling will start at the middle level in the bitrate stage list. If the polling is failed, the next lower bitrate stage will be automatically chosen for the next polling. On the other hand, if the polling is successful, the next higher bitrate stage will be automatically chosen for the next polling. These procedures will repeat until a bitrate stage is found whereby the polling on itself is successful but the polling on the next higher bitrate is failed. Then, this bitrate stage is set as the initial streaming bitrate.

FIG. 28 is a flowchart showing the auto-negotiation procedure which is implemented according to, for example, the corresponding segment of the control program for the computer in the client 12.

With reference to FIG. 28, a first step S200 chooses the first polling bitrate. A step S201 following the step S200 starts the polling with the first polling rate. A step S202 subsequent to the step S201 decides whether or not the polling is successful. When the polling is successful, the step S202 is followed by a step S203. Otherwise, the step S202 is followed by a step S204.

The step S203 chooses the nearest higher bitrate stage as the polling bitrate. A step S205 subsequent to the step S203 starts another polling. A step S206 following the step S205 decides whether or not the polling is successful. When the polling is successful, return from the step S206 to the step S203 is done. Otherwise, the step S206 is followed by a step S207. The step S207 sets the polling bitrate as the initial streaming bitrate.

The step S204 chooses the nearest lower bitrate stage as the polling bitrate. A step S208 subsequent to the step S204 starts another polling. A step S209 following the step S208 decides whether or not the polling is successful. When the polling is successful, the step S209 is followed by the step S207. Otherwise, return from the step S209 to the step S204 is done.

What is claimed is:

1. An MPEG-4 live unicast video streaming system for use in a wireless network including an end-to-end congestion control mechanism that can automatically and dynamically adjust a data-bitrate/transmission bitrate according to an available network bandwidth, the system comprising:
(1) a rate adaptive MPEG-4 simple profile encoder for generating MPEG-4 simple profile live video data through an encoding process with an adjustable encoding bitrate, for transmitting the generated MPEG-4 simple profile live video data by HTTP/TCP through a LAN, and for adjusting the encoding bitrate in accordance with a bitrate control requirement;
(2) a streaming server;
(2a) a data receiver module provided in the streaming server for receiving the MPEG-4 simple profile live video data by HTTP/TCP from the rate adaptive MPEG-4 simple profile encoder through the LAN;
(2b) an RTSP server module provided in the streaming server for handling a streaming session;
(2c) an RTP/RTCP transport engine server module provided in the streaming server for segmentizing the MPEG-4 simple profile live video data received by the data receiver module on the basis of GOVs, for packetizing each GOV as payload of RTP packets, and for transmitting the RTP packets through a wireless network according to a bitrate of each GOV, whereas RTCP is implemented for transporting retransmission request and reply;
(2d) a bitrate adapter module provided in the streaming server for implementing a bitrate adaptation protocol and a network bandwidth polling protocol to allow the streaming server to proceed with bitrate control tasks, and forwarding an incoming bitrate control decision to the rate adaptive MPEG-4 simple profile encoder as the bitrate control requirement;
(2e) a data link buffer provided in the streaming server for storing the MPEG-4 simple profile live video data received by the data receiver module as MPEG-4 GOV data;
(3) a client;
(3a) a rate adaptive MPEG-4 simple profile decoder provided in the client for decoding received MPEG-4 GOV data and rendering pictures represented by the received MPEG-4 GOV data;
(3b) an RTSP client module provided in the client for handling the streaming session;
(3c) an RTP/RTCP transport engine client module provided in the client for receiving the RTP packets from the streaming server through the wireless network, for depacketizing and desegmentizing the payload of the received RTP packets to each GOV of MPEG-4 GOV data, whereas RTCP is implemented for transporting retransmission request and reply;
(3d) a bitrate adapter module provided in the client for implementing the bitrate adaptation protocol and the network bandwidth polling protocol to allow the client to proceed with bitrate control tasks, and for forwarding the bitrate control decision to the streaming server; and
(3e) a data link buffer provided in the client for storing the MPEG-4 GOV data generated by the RTP/RTCP transport engine client module, for collecting bitrate control information, and for forwarding the collected bitrate control information to the bitrate adapter module in the client.

2. An MPEG-4 live unicast video streaming system as recited in claim 1, wherein the data link buffer in the streaming server comprises:
means for storing the MPEG-4 simple profile live video data as a link of GOVs with related information representative of parameters including a GOV bitrate, a GOV duration, and a GOV size;
interfaces for inserting a GOV, reading out a GOV, and searching for a GOV; and
means for, when a speed of GOV reading is slower than a speed of GOV inserting, allowing overwriting an old unread GOV with resynchronization of read and write pointers by resetting a buffer status and dropping rest unread GOVs.

3. An MPEG-4 live unicast video streaming system as recited in claim 1, wherein the RTP/RTCP transport engine server module comprises:
means for segmentizing and packetizing each GOV into RTP packets and then packing one RTP packet as payload of one UDP packet, and for pushing the UDP packet to the client through the wireless network according to a data bitrate;
means for receiving a retransmission request from the client through a UDP connection which loads an RTCP packet with information representative of the retransmission request;
means for, upon receiving the retransmission request, searching the data link buffer in the streaming server for a required GOV;
means for, when the required GOV is found, retransmitting at least a portion of the required GOV which contains required data to the client using RTP packets; and
means for, when the required GOV fails to be found, returning a negative acknowledgement of forbidden-retransmission to the client through an RTCP channel.

4. An MPEG-4 live unicast video streaming system as recited in claim 1, wherein the bitrate adapter module in the streaming server comprises:
means for receiving the bitrate control information from the client as the bitrate control decision and proceeding with bandwidth polling with cooperation of the client; and
means for forwarding the bitrate control decision to the rate adaptive MPEG-4 simple profile encoder as the bitrate control requirement.

5. An MPEG-4 live unicast video streaming system as recited in claim 1, wherein the data link buffer in the client comprises:
means for storing the MPEG-4 simple profile live video data as a link of GOVs with related information representative of parameters including a GOV bitrate, a GOV duration, and a GOV size;
interfaces for inserting a GOV, inserting a blank GOV, inserting data of an incomplete GOV, reading out a GOV, and searching for a GOV;
means for, when a speed of GOV reading is slower than a speed of GOV inserting, allowing overwriting an old unread GOV with resynchronization of read and write pointers by resetting a buffer status and dropping rest unread GOVs;
means for verifying an incomplete GOV and sending a retransmission request corresponding to the verified incomplete GOV to the RTP/RTCP transport engine client module;
means for recovering a complete GOV corresponding to the incomplete GOV from retransmitted data; and
means for collecting a current buffer status as the bitrate control information and sending the bitrate control information to the bitrate adapter module in the client.

6. An MPEG-4 live unicast video streaming system as recited in claim 1, wherein the RTP/RTCP transport engine client module comprises:
means for receiving the RTP packets by a UDP connection through the wireless network, and then desegmentizing and depacketizing the received RTP packets to each GOV;
means for inserting one of an incomplete GOV and a blank GOV into the data link buffer in the client upon occurrence of one of packet loss and packet out-of-sequence;
means for receiving the retransmission request from the data link buffer in the client, and then forwarding the retransmission request to the RTP/RTCP transport engine server module through a UDP connection which loads an RTCP packet with information representative of the retransmission request;
means for, upon receiving the retransmitted data, searching the data link buffer in the client for a specified GOV;
means for, when the specified GOV is found, inserting the retransmitted data or a whole GOV containing the retransmitted data into its position in the data link buffer in the client; and
means for setting a forbidden-retransmission flag of the specified GOV in the data link buffer in the client to forbid a further retransmission request when a forbidden-retransmission RTCP packet is received.

7. An MPEG-4 live unicast video streaming system as recited in claim 1, wherein the bitrate adapter module in the client comprises:
means for receiving the bitrate control information from the data link buffer in the client;
means for making the bitrate control decision in response to the received bitrate control information;
means for forwarding the bitrate control decision to the bitrate adapter module in the streaming server through a TCP connection;
means for, according to the network bandwidth polling protocol, activating a polling process to work with the bitrate adapter module in the streaming server; and
means for initiating an auto-negotiation on an initial streaming bitrate between the streaming server and the client to work with the bitrate adapter module in the streaming server by using the network bandwidth polling protocol.

8. An MPEG-4 live unicast video streaming system as recited in claim 1, wherein each RTP packet has an extended structure including additional fields defined for depacketization and desegmentation.

9. An MPEG-4 live unicast video streaming system as recited in claim 3, wherein the RTCP packet has a user application structure including additional fields defined for retransmission.

10. An MPEG-4 live unicast video streaming system as recited in claim 1, wherein each of the data link buffer in the streaming server and the data link buffer in the client stores a GOV in one GOV node with related information.

11. An MPEG-4 live unicast video streaming system as recited in claim 1, further comprising a retransmission mechanism for retransmitting data from the streaming server to the client, the retransmission mechanism including the data link buffer in the client, the RTP/RTCP transport engine client module, and the RTP/RTCP transport engine server module.

12. An MPEG-4 live unicast video streaming system as recited in claim 1, further comprising means provided in the bitrate adapter module in the streaming server and the bitrate adapter module in the client for implementing the network bandwidth polling protocol.

13. An MPEG-4 live unicast video streaming system as recited in claim 1, further comprising means provided in the data link buffer in the client, the bitrate adapter module in the streaming server, and the bitrate adapter module in the client for implementing the bitrate adaptation protocol.

14. An MPEG-4 live unicast video streaming system as recited in claim 13, wherein the bitrate adaptation protocol includes a bitrate decision rule with implementation of a decision sliding window.

15. An MPEG-4 live unicast video streaming system comprising:
an MPEG-4 encoder encoding an information signal into MPEG-4 data composed of successive GOVs at an adjustable encoding bitrate and outputting the GOVs, and adjusting the encoding bitrate in accordance with a bitrate control signal;
a streaming server receiving the GOVs from the MPEG-4 encoder;
first means provided in the streaming server for changing each received GOV into packets;
second means provided in the streaming server for wirelessly transmitting the packets generated by the first means;
a client wirelessly receiving the packets from the streaming server;
third means provided in the client for changing the received packets into each recovered GOV;
a buffer memory provided in the client for temporarily storing recovered GOVs generated by the third means;
fourth means for reading out each GOV from the buffer memory;
fifth means for calculating a remaining playback time corresponding to GOVs in the buffer memory which have not yet been read out by the fourth means;
sixth means provided in the client for generating the bitrate control signal in response to the remaining playback time calculated by the fifth means;
seventh means for wirelessly transmitting the bitrate control signal generated by the sixth means to the streaming server; and
eighth means for transmitting the bitrate control signal from the streaming server to the MPEG-4 encoder.

16. An MPEG-4 live unicast video streaming system as recited in 15, wherein the fourth means comprises an MPEG-4 decoder decoding each GOV read out from the buffer memory into a corresponding portion of an original information signal.

17. An MPEG-4 live unicast video streaming system as recited in 15, further comprising:
ninth means for deciding whether or not each GOV in the buffer memory is short of data and requires absent data;
tenth means for, when the ninth means decides that a GOV in the buffer memory is short of data and requires absent data, generating a retransmission packet loaded with the absent data in the streaming server;
eleventh means for wirelessly transmitting the retransmission packet from the streaming server to the client;
twelfth means provided in the client for extracting the absent data from the retransmission packet; and
thirteenth means provided in the client for inserting the absent data extracted by the twelfth means into the data-short GOV in the buffer memory.
